(19) United States
(12) Patent Application Publication
(10) Pub. No.: US 2006/0129461 A1
(43) Pub. Date: Jun. 15, 2006

(54) Data entry and system for automated order, design, and manufacture of ordered parts

(76) Inventors: Gerold Pankl, Huntington Beach, CA (US); Nils A. Nohturfft, Huntington Beach, CA (US)

Correspondence Address: Anthony L. Mlele;Miele Law Group, 137 South Main Street, Natick, MA, 01760, US

(21) Appl. No.: 11/009,959

(22) Filed: Dec. 10, 2004

(51) Int. Cl. G06Q 30/00

(52) U.S. Cl. 705/26

(57) ABSTRACT

A part data entry system is provided. In that system, an order processing template is provided to facilitate sales and order processing, tool planning, CA (computer aided) (e.g., CAD/CAM) parametric modeling, computer simulation, and the generation of a factory machine program. The order processing template comprises financial and manufacturing engineering planning fields and technical fields. A part information population mechanism is provided to populate the order processing template with the part information. An order template population mechanism is provided to populate other ones of the financial and manufacturing planning fields and the technical fields that are not populated by the part information population mechanism. An order processing template interface, or a set of such interfaces, is provided to provide, for a given ordered part, from the order processing template, CA-specific information to a CA computer system before the CA computer system performs CAD modeling on the part. The order processing template interface further provides, for the given ordered part, from the order processing template, ERP-specific information to an ERP computer system before the ERP computer system performs scheduling of machines and resources, material reservation, or RFQ calculations.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

The present invention relates to certain types of systems for custom manufacturing.

Custom manufacturing involves a customer (e.g., using an online connection via the Internet) electronically communicating his or her preferences for a given product. The customer may even jointly design the end product with the manufacturer. This may be done with the help of a salesperson or distributor representing the customer through the process.

In a custom manufacturing process, a given product starts with procurement by the customer (e.g., online ordering; an RFQ process). Then, there is a needs assessment.

In the needs assessment, the product design and manufacturing plan are assessed so that supply issues may be addressed. For example, the manufacturer may need to order tools or materials for the product.

In generating the design, certain information, required for parameterization of the part, may be input by an engineer. A manufacturing plan and program are then each developed. Part or all of these may be developed before or concurrent with the needs assessment. In addition, the part may be modeled by a CAD/CAM system, and various simulations may be performed on the modeled part with the aid of one or more simulation modules of the CAD/CAM system.

The generated plan and program may collectively include: tool setup instructions; scheduling information (for scheduling of various steps in the manufacturing process), and specific machining and tool operations in CNC code (otherwise called NC code).

Some industries require substantial part customization with little time to deliver the product to the customer. As one example, during racing season, racing teams repeatedly redesign their engines according to an aggressive schedule. A given racing team optimizing one of its cars may vary the shape, weight, and/or weight distribution of the engine's combustion chamber, shaft, and/or pistons. Conrods, gear boxes, and gear wheels may also be varied.

As another example, in the engine part prototyping industry, engine part manufacturers and designers require the prompt production and delivery of custom engine part prototypes.

### BRIEF SUMMARY OF THE INVENTION

In a custom order processing and execution system, certain information is gathered at various points in the process, and the flow of that information is managed throughout the process from order submission to design, planning, manufacturing and reporting. The manner in which this information is gathered and managed can impact on the efficiencies and operation of the entire order processing and execution system and all its processes.

There is a need for advances in information input and information flow management in custom order processing and execution systems. Such advances may help eliminate (or mitigate) the need for re-keying of information, as such re-keying can lead to inefficiencies and an increased risk of inaccuracies. In addition, with the right advances in these features, the transitions among the various stages of the order processing and execution process can be faster. The quality of the manufacturing program generated may also be enhanced.

Advances in information input and information flow management can also decrease the lead-time needed to design and manufacture a custom product, and improve the quality of the resulting product. Manufacturing costs may also be reduced.

With the certain advances in information input and information flow management, the customer is presented with added options and flexibility, e.g., in terms of product customizability and delivery times, and the process can be easier to manage for both the customer and the manufacturer.

### BRIEF DESCRIPTION OF THE DRAWINGS

FIG. 1 is a high level block diagram of an improved custom order processing and execution system;

FIG. 2 is a block diagram of information flow in the improved custom order processing and execution system of FIG. 1;

FIG. 3 is a schematic diagram of exemplary order entry and processing portions of an order processing and execution system;

FIG. 4 is a schematic diagram of an order processing template;

FIG. 5 is a schematic diagram of the other data entry interfaces shown in the block diagram of FIG. 3;

FIG. 6 is a block diagram of an example configuration of a networked system to implement the system showing FIG. 1;

FIG. 6A is a flow chart of a process for a first type of automation;

FIG. 6B is a flow chart of a process for a second type of automation;

FIG. 7 is a perspective drawing of a shaft;

FIG. 8 is a block diagram of a setup process;

FIGS. 9A-9E are schematic diagrams of an order entry interface, in five separate parts;

FIG. 10 is a schematic diagram of a needs entry interface;

FIG. 11 is a schematic diagram of a sequence of operations planning entry interface;

FIG. 12 is a schematic diagram of a machine loading and scheduling data interface;

FIG. 13 is a schematic representation of a portion of the technical mask populated with data for a shaft;

FIG. 14 shows populated data corresponding to a portion of stock overview data;

FIG. 15 shows populated data corresponding to a stock movement journal;

FIG. 16A shows populated data for a new order processing for a given sequence of operations plan;

FIG. 16B depicts a production plan for a sequence of operations, including bar code setup and runtime inputs for a machine operator;

FIG. 17 depicts an example RFQ;

FIG. 18 depicts an example of an automated quote;

FIG. 19 is an example of standard costing data; and

FIG. 20 is a flow chart of a specialty machine programming process.

### DETAILED DESCRIPTION OF THE INVENTION

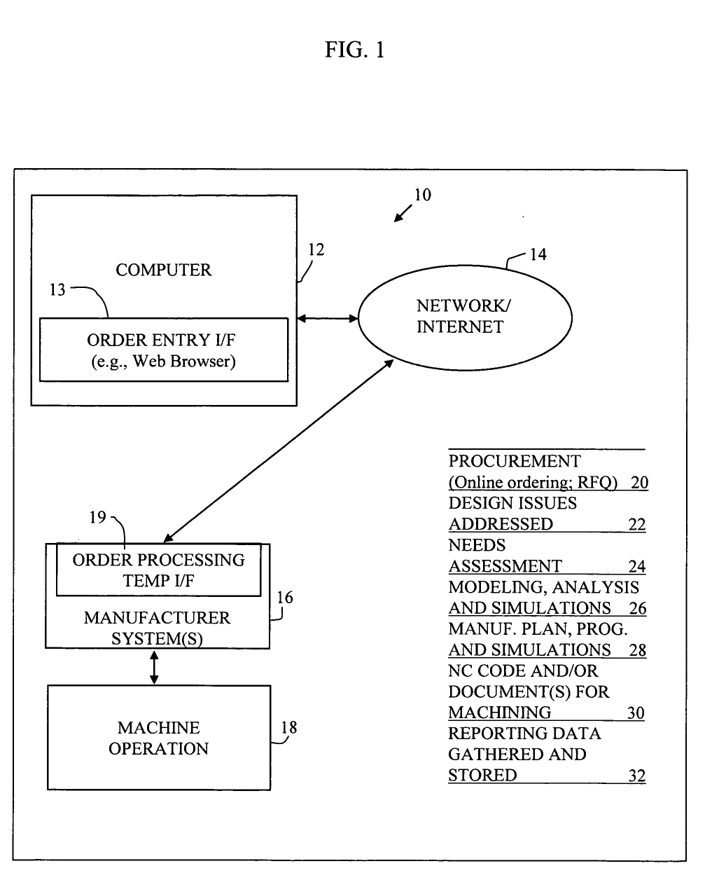

Referring now to the drawings in greater detail, FIG. 1 is a block diagram of an improved custom order processing and execution system 10. The illustrated system 10 comprises a computer 12 coupled to one or more manufacturer systems 16, via a network 14 (e.g., including the Internet). The computer 12 may be a customer or a manufacturer or manufacturer representative computer.

Manufacturer systems 16 are connected to a machine operation 18. The illustrated custom order processing and execution system 10 may perform or facilitate a number of functions, including those illustrated in FIG. 1 to the right of the diagram. Specifically in a procurement phase 10 of an order—manufacture process, a particular custom part is ordered, and an RFQ (request for quote) is submitted by a customer and responded to. Certain design issues are addressed in phase 22. Such design issues may be addressed by manufacturer systems 16. At a next phase 24, a needs assessment is done, which involves, for example, tool and material ordering. At phase 26, the manufacturer systems perform modeling, analysis and simulations. In phase 28, a manufacturing plan and a program are produced, and further simulations are performed, e.g., by a CA (computer aided) computer system. In phase 30, NC code and/or program instruction documents are produced for machining, in the machine operation 18. In phase 32, reporting data is gathered and stored.

In the embodiments herein, a CA computer system may comprise all (or a given subset, as appropriate) of a CAD (computer aided design) component, a CAM (computer aided manufacture) component, a CAE (computer aided engineering), and a CAQ (computer aided quality) component. For this purpose, the term “component” refers to a computer system, a module within a computer system, or a portion of a computer system that may or may not be modular or a separable software module. A computer system may be embodied in the form of software running on a given platform, which may be a single computer or a distributed processing environment. The CA computer system (which may comprise several separate computer systems), or any given component thereof, may be a commercially-available product or may be developed especially for the embodiment.

In procurement phase 20, an order entry process is performed, which can involve entering order data directly into an ERP (enterprise resource planning) system, or directly into an order entry interface of computer 12. The order entry interface may be a web browser, which may then interact with a server portion of an ERP computer system or PLM or of a CA system. Manufacturer systems 16 may be provided with an RFQ automated quote mechanism which handles standard costing setup for the ordered part and handles and effects an automated order confirmation to the customer.

As design issues are addressed in phase 22, a CA system may perform analyses. Alternatively, engineering personnel, sales personnel, and the customer may work together to refine the order and the design of the requested custom part. By way of example, drawings or a 3D model may be produced or refined, where such drawings or 3D model were produced by the customer, by the manufacturer's engineering personnel, or by a combination of the two. In other words, the customer may submit drawings or a 3D model, which are then refined or revised by the manufacturer's engineering personnel.

During the needs assessment phase 24, an assessment is made regarding the tools and materials that will be required to manufacture the custom part. Where necessary, information regarding the needed ordering of tools may be forwarded from a CA system to an ERP system to which it is connected, to effect the ordering of the needed tools. In addition, a bill of material (BOM) may be generated whereby the ERP creates an automatic purchase order suggestion for needed additional materials. The BOM may be generated by the CA system and forwarded to the ERP computer system directly or via a PLM system.

In phase 26, modeling, analysis, and simulations may be performed, e.g., by a CA system, to verify the design, CAM tool paths and/or NC code and to provide information that may be needed for local (automated or manual) optimization of the manufacturing process. For example, the customer may desire that a given part be very light, while the part strictly adheres to certain performance criteria. Analysis and simulation modules may be used to determine if a given design will meet these criteria. If it does not, the design may be modified, and an additional analysis may be performed before proceeding to a final plan and program. The final plan and program may comprise documentation instructing the operation of the machines, instructing the setup of the same, and/or NC code. As a byproduct of the manufacturing plan, an operation sequence may be generated with bar codes, for use by a machine operator to record time against the job when it is performed (performance reporting).

During the development of the manufacturing plan and program in phase 28, the manufacturer systems 16 generate a CAM program which will form the basis later for generation of either NC (numerically controlled) code, or documents instructing the proper operation of a machine to carry out the manufacturing of the custom product.

Manufacturer systems 16 comprise an order processing template interface 19 which provides, for a given ordered part, from the order template, CA—specific information to a CA component of manufacturer systems 16 before that component performs any CAD modeling or CAE calculation on the part, and to provide, for the given ordered part, from the order template, ERP or PLM (product lifecycle management) specific information to an ERP or PLM component of manufacturer systems 16 before the ERP component performs any scheduling of machines and resources, material reservation, or RFQ calculations and before the PLM component performs certain data management functions including the storage and linking of meta data and/or documents, specifications etc. corresponding to each component of the part.

Manufacturer systems 16 may comprise an ERP system such as SAP's system called MySAP (formerly called R2) or a BAAN system and/or components thereof. Manufacturer systems 16 may comprise a CA system such as the UGS's NXIII system, or the Catia V5 system and/or components thereof. In addition to any ERP system, or alternative to any ERP system, a PLM (produce lifecycle management)/PDM (product data management) such as the UGS TeamCenter Engineering/Manufacturing system, or the IBM smartteam system, may be provided.

Order entry interface 13 of computer 12 may comprise a web browser, as noted in FIG. 1, or it may comprise an interface of an ERP system or a PLM system. Alternatively, order entry interface 13 may be embodied by Microsoft Access or by Microsoft Excel or any other custom or commercial software with data interface capabilities. Illustrated manufacturer systems 16 may comprise a reporting mechanism, which may comprise a web browser access. Other manufacturer system software modules may be running on such a system. The platform or platforms of the manufacturer systems may comprise individual computer systems or distributed processing platforms.

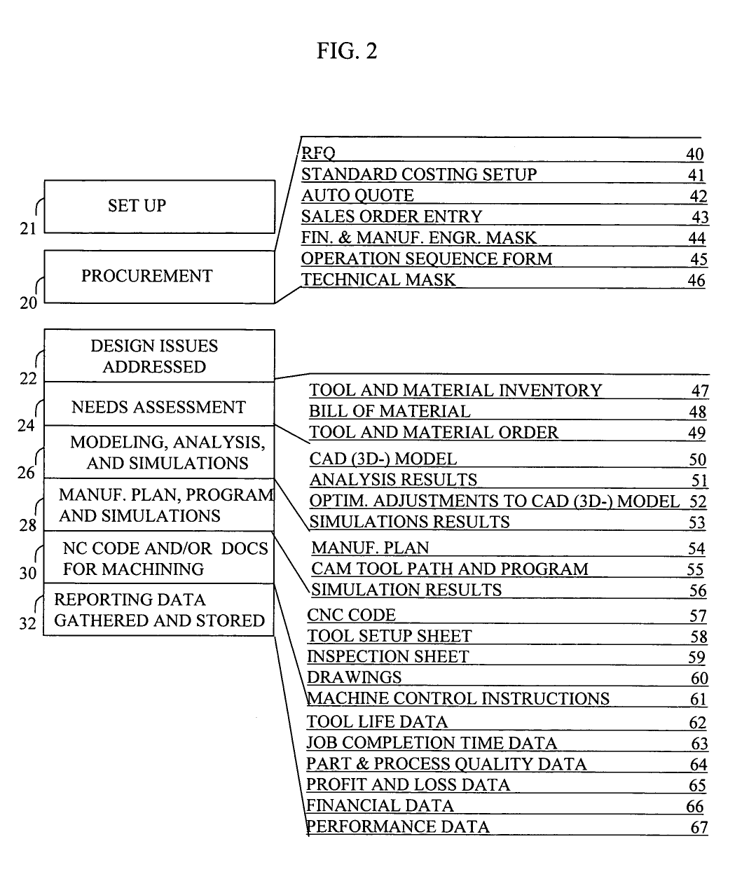

FIG. 2 is a block diagram of the information flow of the improved custom order processing and execution system shown in FIG. 1. This diagram depicts information that flows through phases 20-32 (also shown in FIG. 1), with the addition of an initial phase called a setup phase 21. A setup phase 21 is initially carried out to set up the custom order processing and execution system 10. For example, both CA software and ERP software may be set up. In addition, products and product families suitable for automation may be defined. Each of phases 20, 22, 24, 26, 28, 30, and 32 is described above.

During all these phases, various information items, such as documents or stored data structures, are either created, provided, or populated. As illustrated in FIG. 2, procurement phase 20 may produce information items that include an RFQ 40, a standard costing setup 41, an automated quote 42, a sales order entry item 43, a financial and manufacturing engineering mask 44, an operation sequence form 45, and a technical mask 46.

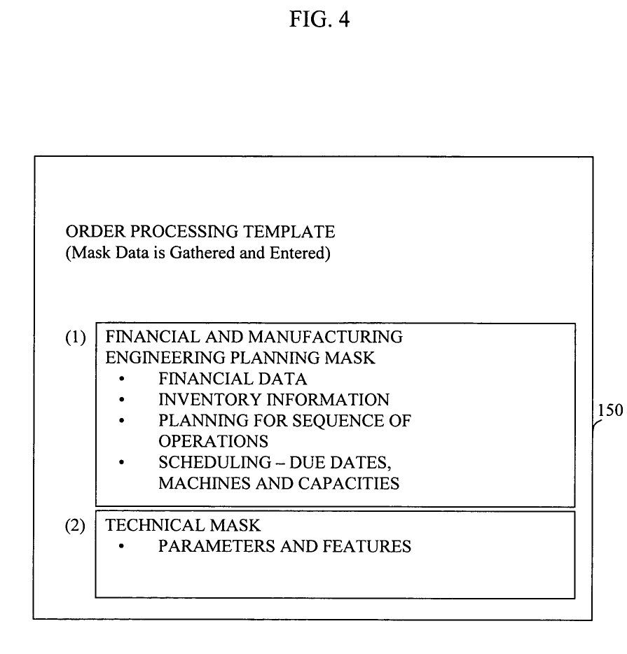

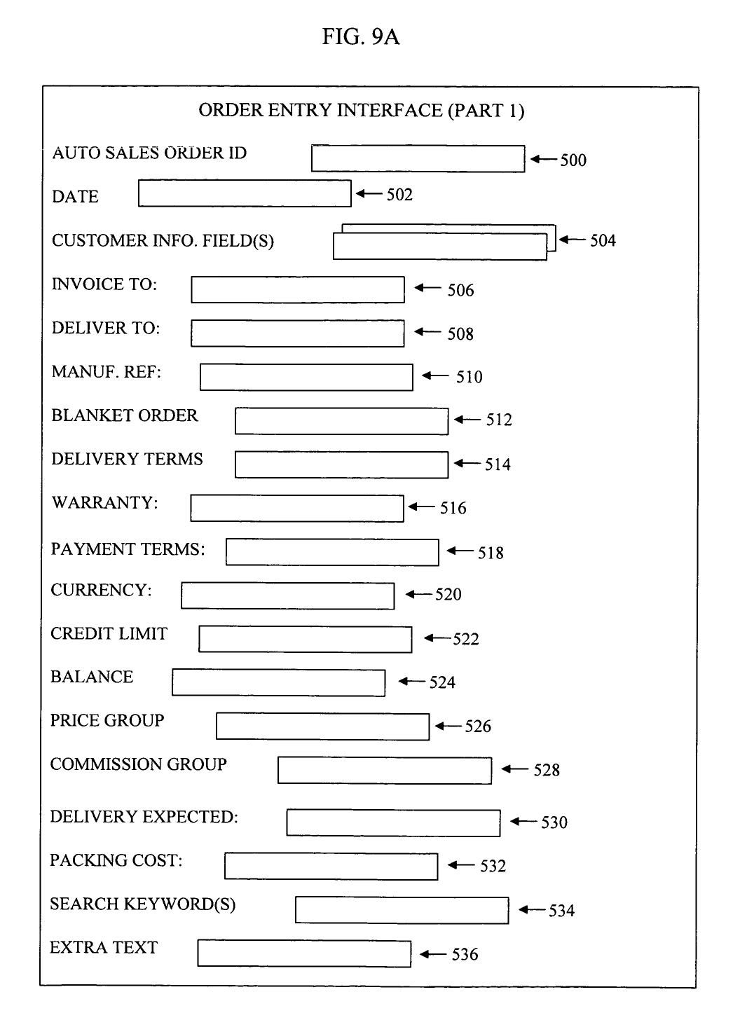

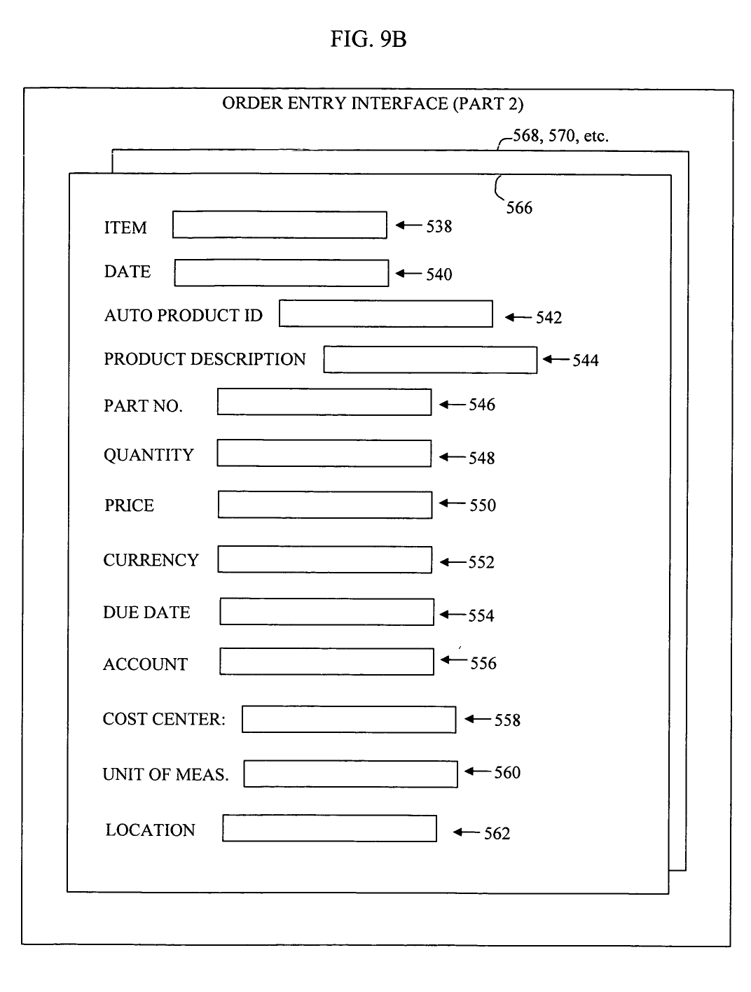

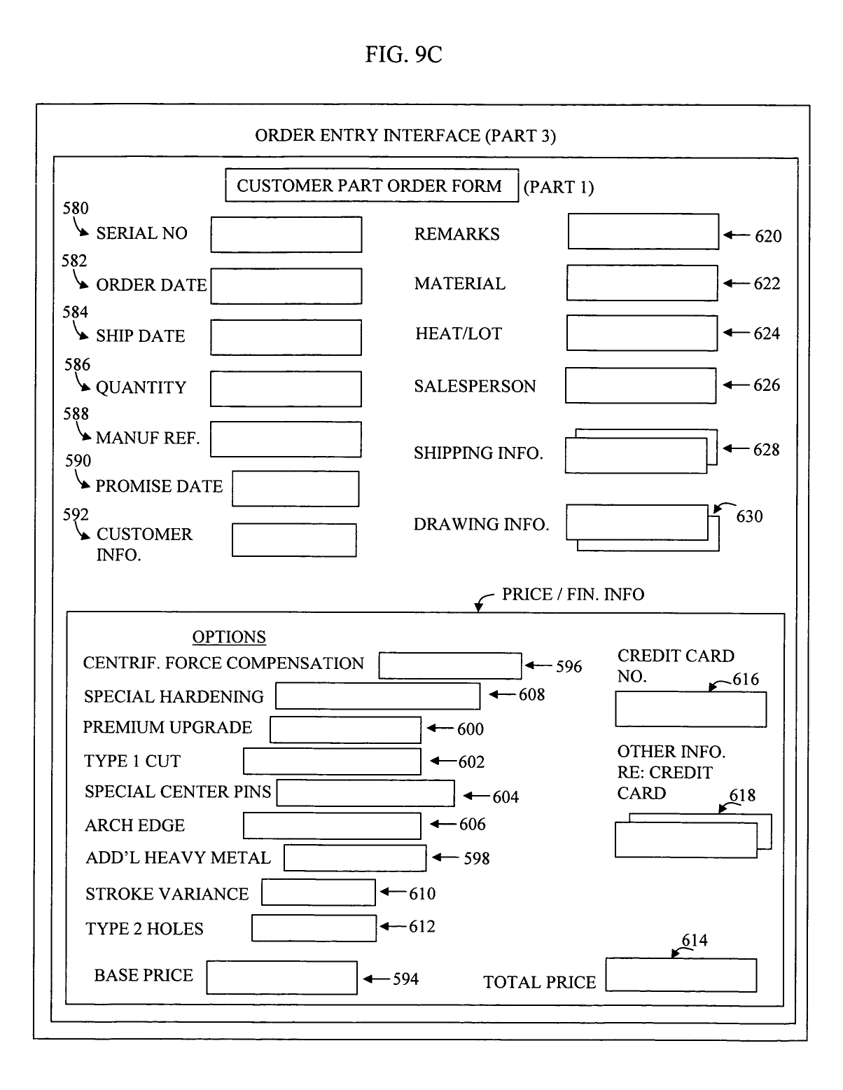

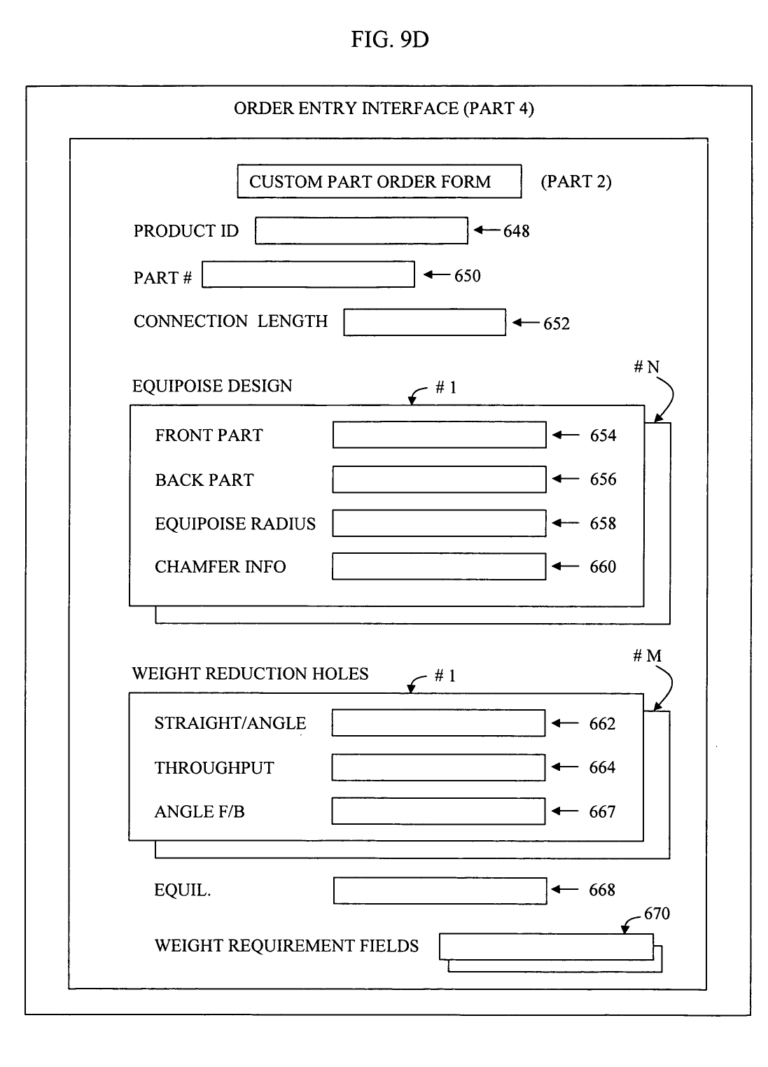

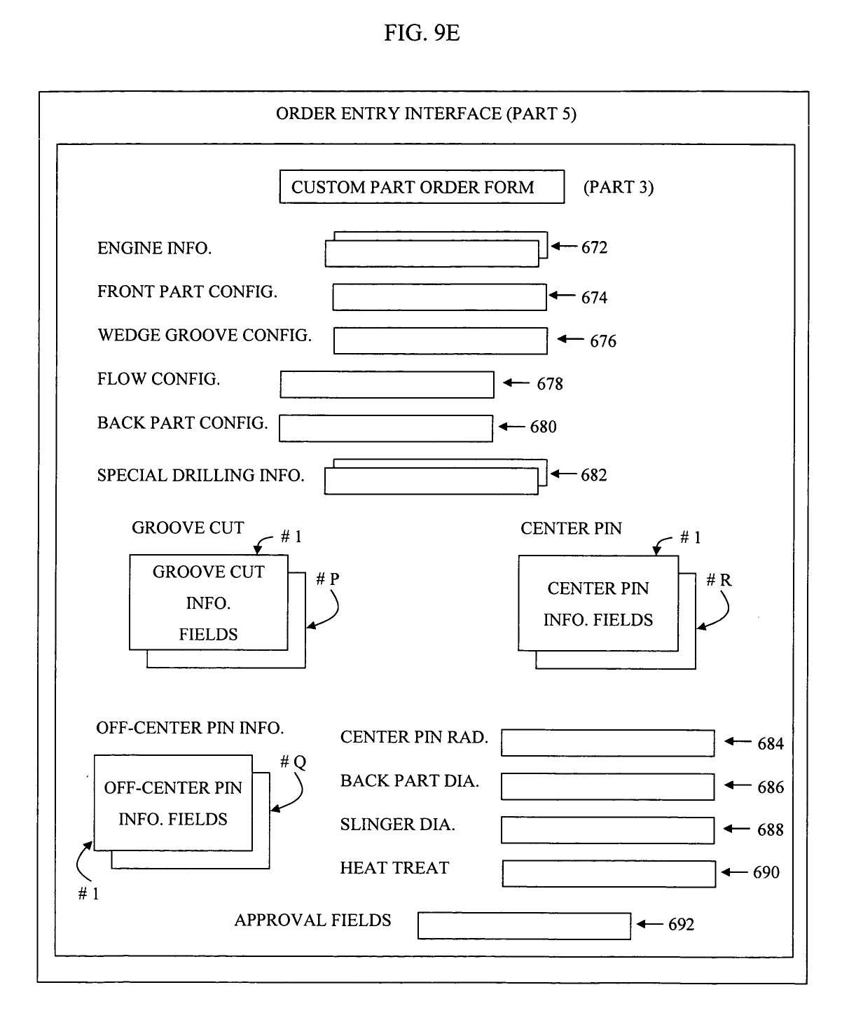

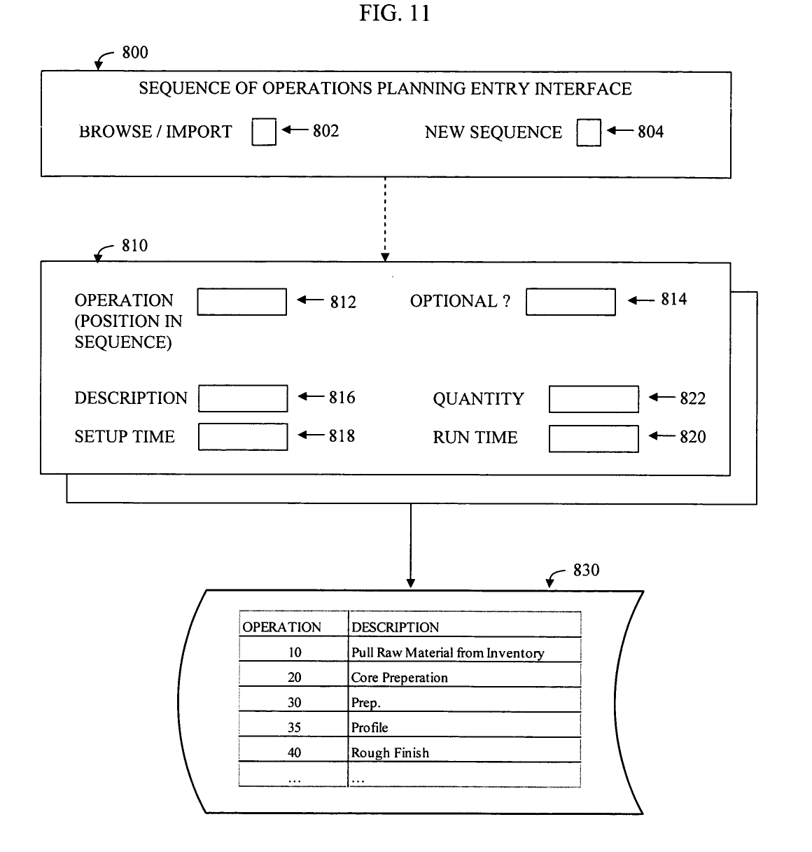

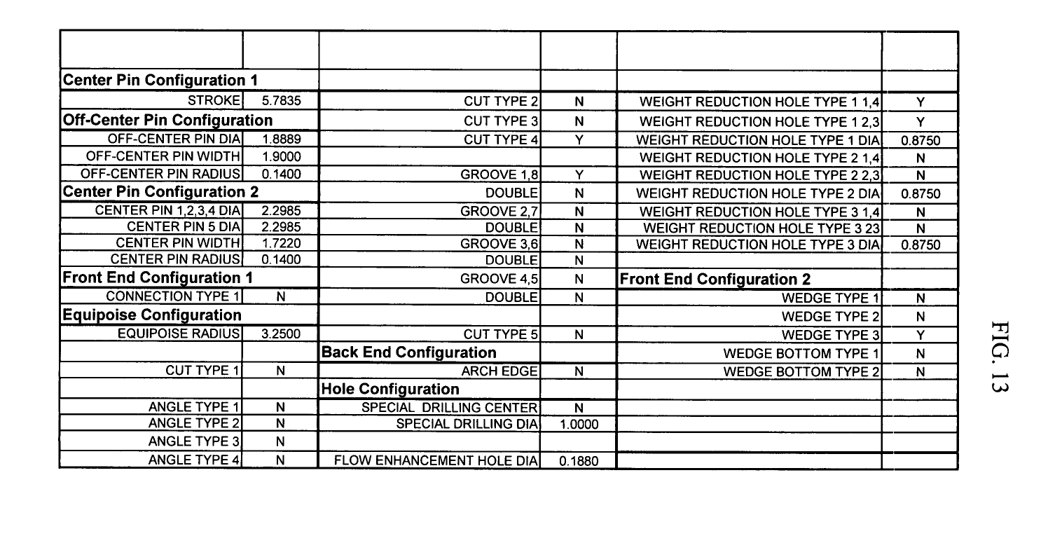

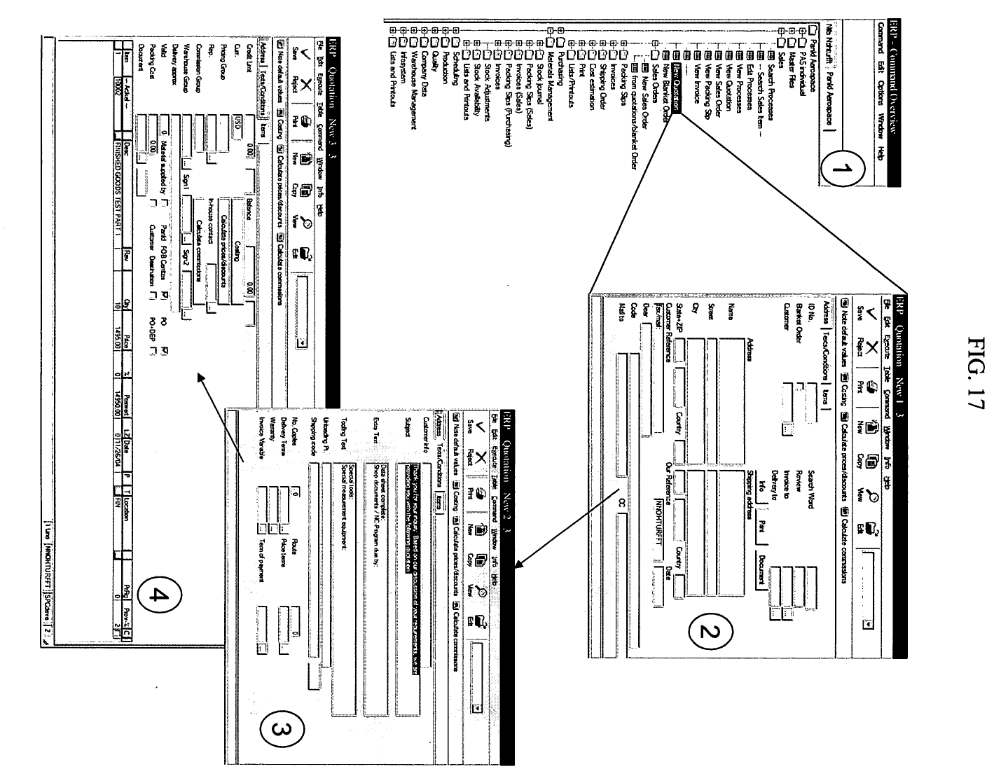

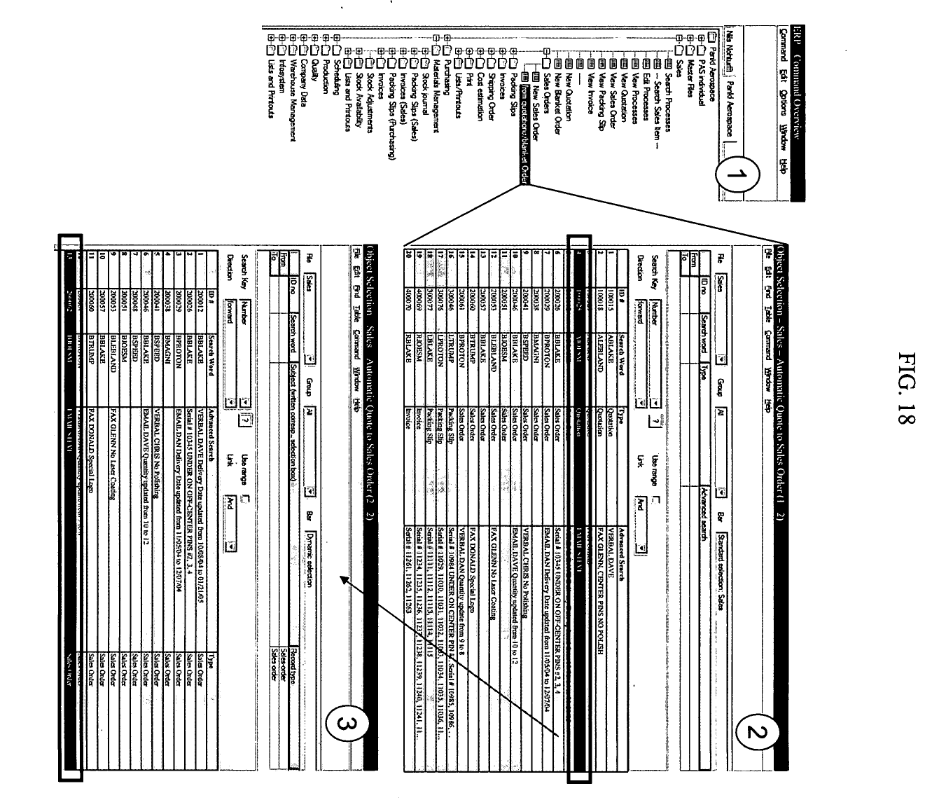

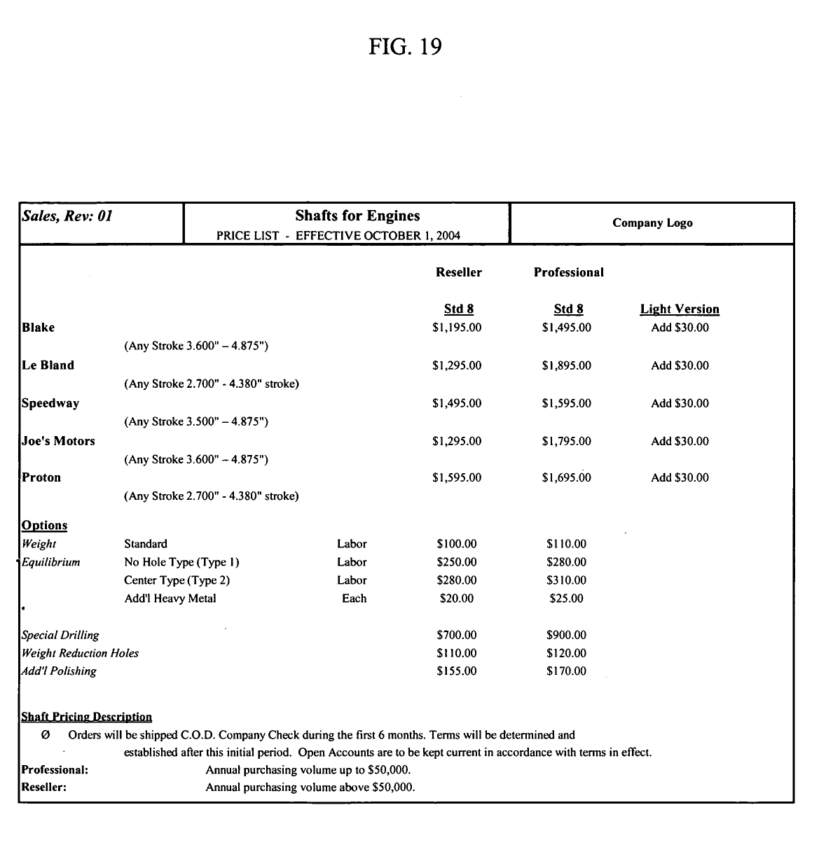

Sales order entry item 43 comprises information that can be obtained from the fields in the order entry interface shown in FIGS. 9A-9E. Technical mask 42 and financial and manufacturing engineering mask 44 correspond to the two masks shown in FIG. 4. An example of a technical mask (or portions thereof) is illustrated in FIG. 13. An example of financial and manufacturing engineering mask 44 (or portions thereof) is illustrated in FIGS. 9A, 9B, 9C, 10 and 11. An example of an RFQ is shown in FIG. 17. An example of an automated quote 42 is shown in FIG. 18. A standard costing setup 41 is shown in FIG. 19. An example of an operation sequence form 45 is shown in FIG. 11.

During the needs assessment phase 24, information items may be produced (created, provided, or populated), including a tool and material inventory 47, a bill of material 48, and a tool and material order 49.

During phase 26 in which modeling, analysis and simulations are performed, items are created including a CAD model or CAD 3D-model 50, analysis results 51, optimization adjustments to the CAD model or CAD 3D-model 52, and simulation results 53. During phase 28, during which manufacturing planning, creation of a program and simulations are performed, items are created including a manufacturing plan 54, a CAM tool path and program 55, and simulation results 56.

During phase 30 at which the NC code and/or documents are generated for machining, information items that may be produced include CNC code 57, a tool setup sheet 58, an inspection sheet 59, drawings 60, and machine control instructions 61.

During the reporting data gathered and stored phase 32, information items are generated such as tool life data 62, job completion time data 63, and part and process quality data 64 (which may include process deviation data). Other items may include profit and loss data 65, financial data 66, and performance data 67.

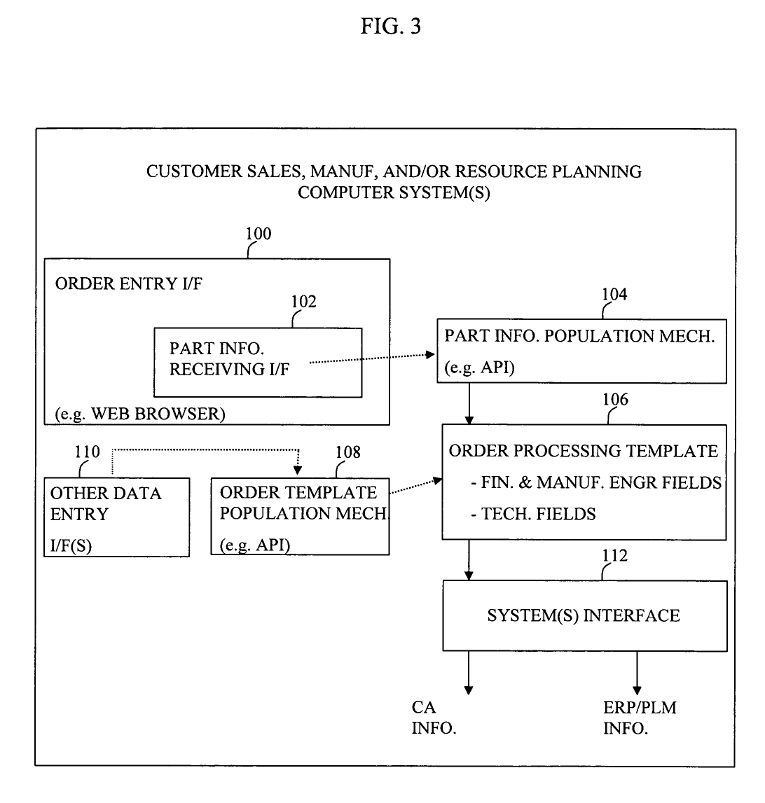

FIG. 3 is a block diagram of exemplary order entry and processing portions of a manufacturer computer system. The illustrated order entry and processing portions may be of the customer sales, manufacturing, and/or resource planning computer systems. In the embodiment illustrated in FIG. 3, those systems comprise, among other elements not specifically shown in FIG. 3, an order entry interface 100, a part information population mechanism 104, an order processing template 106, an order template population mechanism 108, and one or more order data entry interfaces 110. The systems further comprise of one or more system interfaces 112.

Order entry interface 100 comprises a part information-receiving interface 102 to receive part information. In the illustrated embodiment, the part information is received via a computer screen input. More specifically, the part information may be received via a web browser. More specifically, the part information may be provided by a customer or by a sales engineer. In one specific embodiment, a mechanism may be provided for allowing the customer to provide the part information through an online customer order interface using a web browser.

The order-processing template 106 facilitates sales and order processing, tool planning, CA parametric modeling, computer simulation, and the generation of a factory machine program. Order processing template 106 may comprise financial and manufacturing engineering planning fields and technical fields.

A part information population mechanism 104 is provided, to populate order-processing template 106 with the part information obtained from a part information interface 102. The order-processing template 106 may comprise a set of preparation masks. Those masks may comprise order execution preparation masks. In the specific embodiment illustrated in FIG. 3, those masks include a first mask comprising financial and manufacturing engineering fields and a second mask comprising technical fields.

An order template population mechanism 108 is provided to populate other ones of the financial and manufacturing engineering planning fields and the technical fields of the order processing template 106, where such other fields were not populated by part information population mechanism 104. These other fields, therefore, may comprise supplemental information input by staff, such as by sales, manufacturing or design engineering staff of the manufacturer, through a user interface, such as one or more other data entry interfaces 110.

An interface 112 is provided to interface the order-processing template 106 with other systems, e.g., a CA system and an ERP and/or PLM system. Specifically, interface 112 provides, for a given ordered part, from the order-processing template 106, CA—specific information to a CA system before the CA system performs CAD modeling or CAE calculations on the part. Interface 112 further provides, for the given ordered part, from order processing template 106, ERP and/or PLM—specific information to an ERP and/or PLM system before the ERP system performs scheduling of machines and resources, material reservation, or RFQ calculations, and the PLM system performs data management.

In the illustrated embodiment, the illustrated data entry interfaces 100 and 110 comprise computer screen input mechanisms, such as graphical user interfaces used with other computer input devices such as a keyboard and a mouse or other cursor control device. Those interfaces may further comprise custom or commercial interface software that presents to the user, on the computer screen, the appropriate icons, forms, or other graphical “input prompting” mechanisms to facilitate the input of information. Other embodiments may include file retrieval icons for importing data from specified files. In addition, the entry interfaces may comprise a browse button for accessing files to be imported.

The illustrated population mechanisms, including part information population mechanism 104 and order template population mechanism 108, may comprise an application programming interface (API). An API call may be performed by the computer system upon which the order entry interfaces 100 and 110 are provided, to each of these population mechanisms 104 and 108, causing the data that has been stored as a result of the data entry to be populated into the fields of the data structure, i.e., of order processing template 106.

That data structure, i.e., order processing template 106, may be stored in a database on, for example, some portion of the manufacturer systems 16, as shown in FIG. 1, and/or in one or more files. Order processing template 106 may be in the form of one or a combination of several data formats, e.g., including XML and one or more text files.

FIG. 4 is a schematic diagram of an order-processing template 150. The illustrated order-processing template 150 comprises mask data that is gathered and entered through various means, e.g., the order entry interfaces shown in FIG. 3. The illustrated order-processing template 150 comprises, in the embodiment illustrated in FIG. 4, two masks. Specifically, it comprises a financial and manufacturing engineering planning mask and a technical mask. The illustrated financial and manufacturing engineering planning mask comprises financial data; inventory data; planning for sequence of operations; and scheduling data. The scheduling data may comprise due dates, machines, and capacities. The technical mask comprises data such as parameters and features of the ordered part.

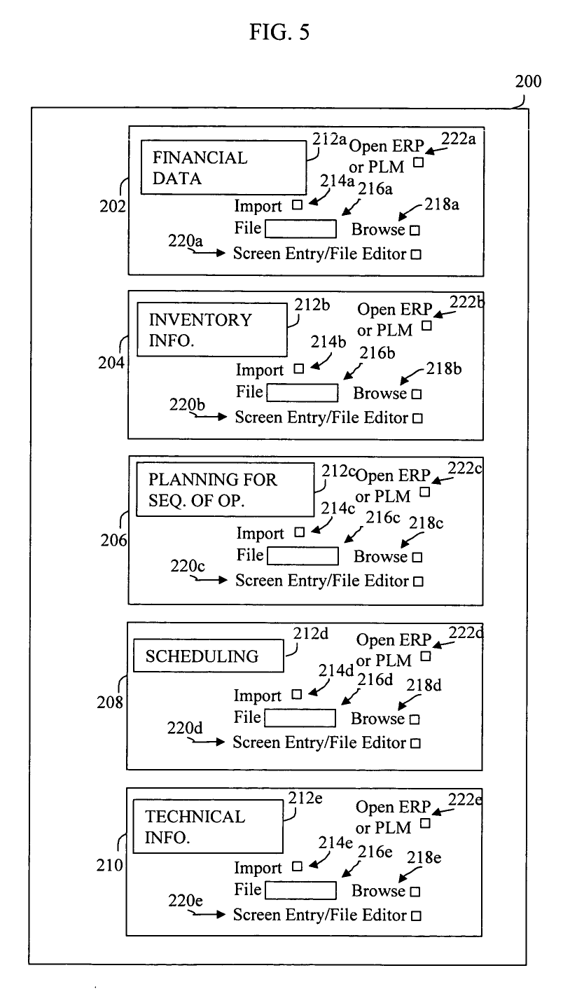

FIG. 5 is a schematic diagram of an example of the other data entry interfaces shown in the block diagram of FIG. 3. The illustrated other data entry interfaces 200 comprise a financial data entry interface 202 for inputting or gathering financial data 212a, and inventory information interface 204 for gathering inventory information 212b, a planning for sequence of operations interface 206 for gathering such information 212c, a scheduling interface 208, for gathering scheduling information 212d, and a technical information interface 210 for gathering technical information 212e.

The illustrated financial data interface 202 may comprise an import button 214a for access to an import function for inputting the data from another file, a file designation field 216a, a browse button 218a, and a screen entry/file editor button 220a. It may further comprise a button 222a to open an associated ERP and/or PLM computer system. The illustrated file field 216a comprises a field in which the file path and name can be typed. The browse button 218a is a button which can provide the user with access to various file paths to locate a particular file for importation as financial data. The screen entry/file editor button 220a may comprise a button which provides access to a screen entry function for entering data directly into the screen and/or a file editor function for editing the information in a given file that may be obtained, for example, via the import function, via the file field 216a, and/or via the browse function 218a.

Each of the inventory information interface 204, planning for sequence of operations interface 206, scheduling interface 208 and technical information interface 210 may comprise interface components comparable to interface components 214a, 216a, 218a, 220a and 222a. Those corresponding interface elements have similar reference numbers, with an alphabetical character b for interface 204, c for interface 206, d for interface 208, and e for interface 210.

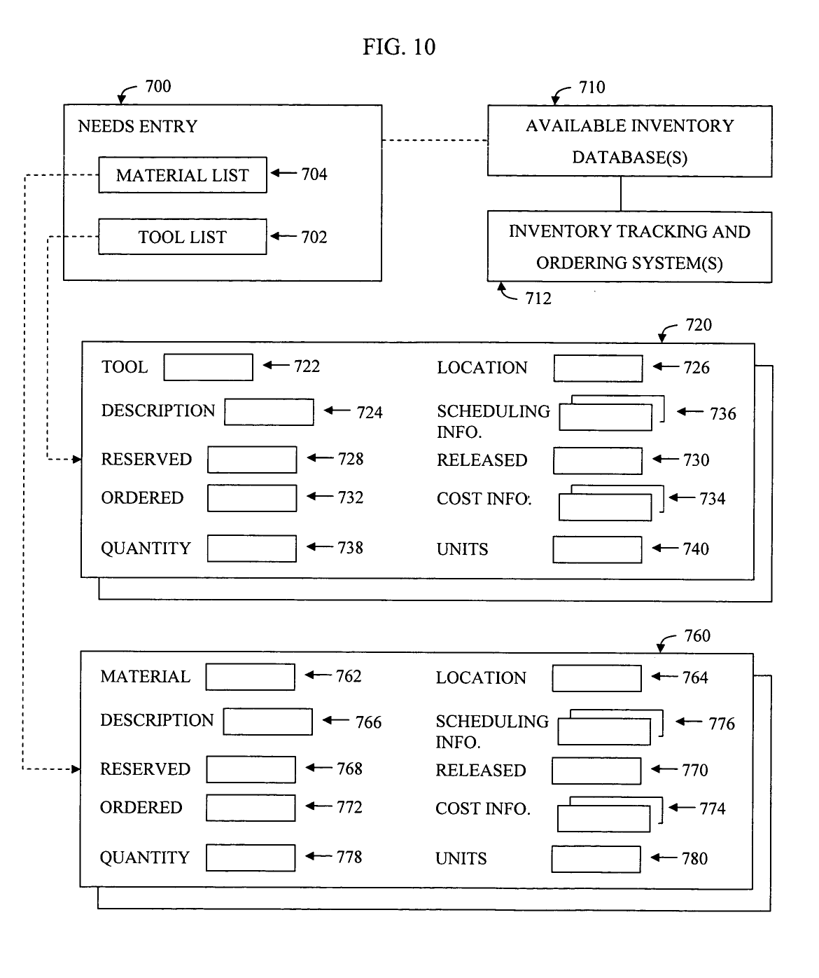

By way of example, financial data interface 202 may collect data that is obtained through certain portions of the order entry interface, particularly portions of that interface shown in parts of FIGS. 9A, 9B, and 9C. Inventory information interface 204 may be implemented in the form of the interface shown in FIG. 10, or the file information may be gathered through the use of the interface components shown in FIG. 5 by accessing the data input in the interface shown in FIG. 10.

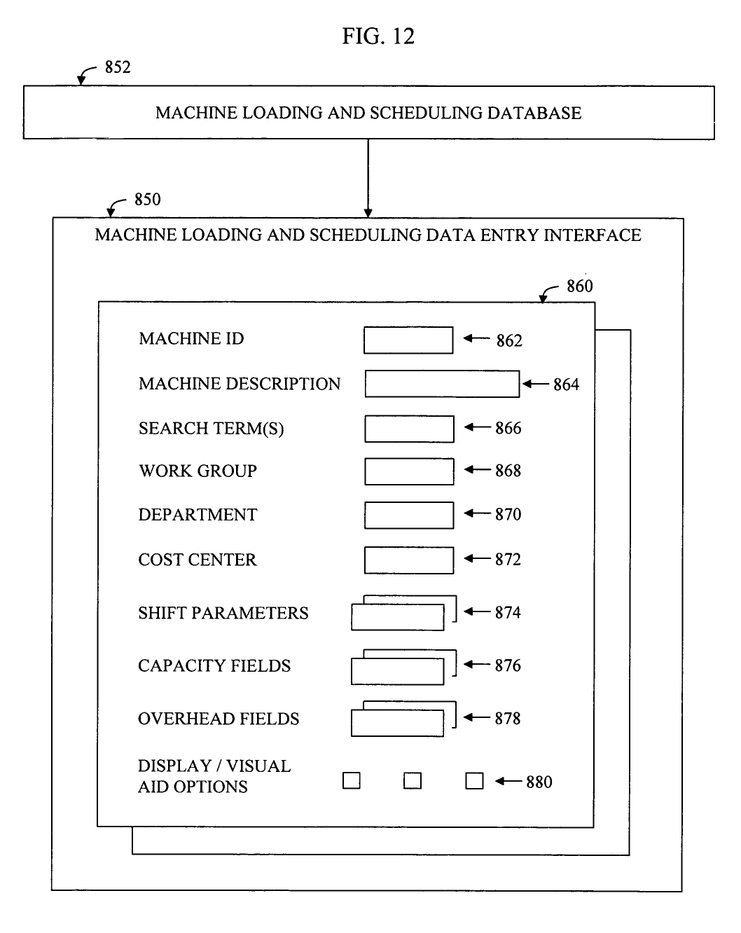

The interface 206 for planning for sequence of operations may be implemented in the form of the interface shown in FIG. 11. The scheduling interface 208 may be implemented in the form illustrated in FIG. 12. The technical information interface 210 may be implemented like the interface shown in FIG. 13.

Each of those interfaces as depicted in FIGS. 9A-9E, FIG. 10, FIG. 11, FIG. 12, and FIG. 13, will be further described below.

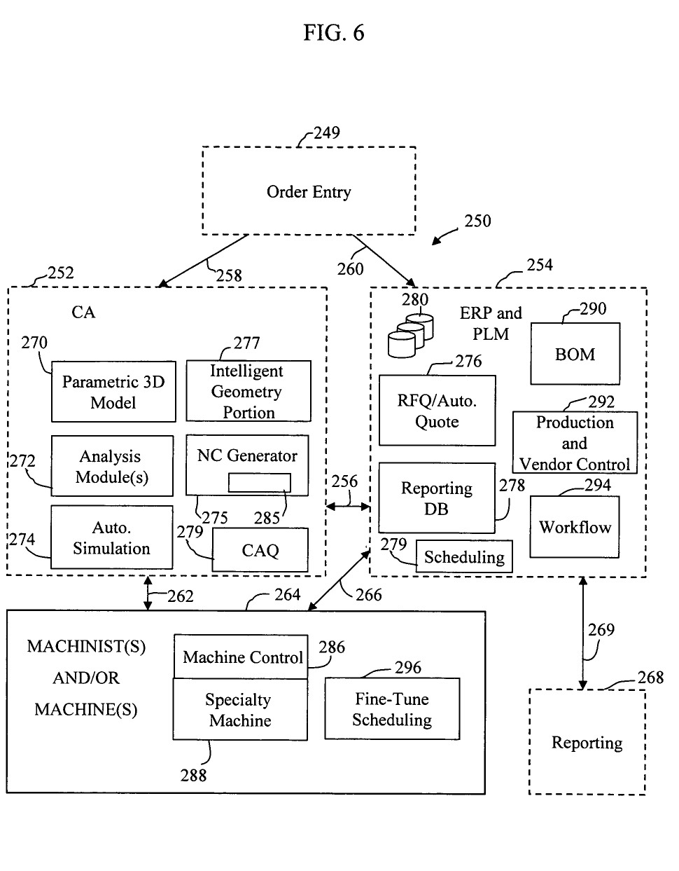

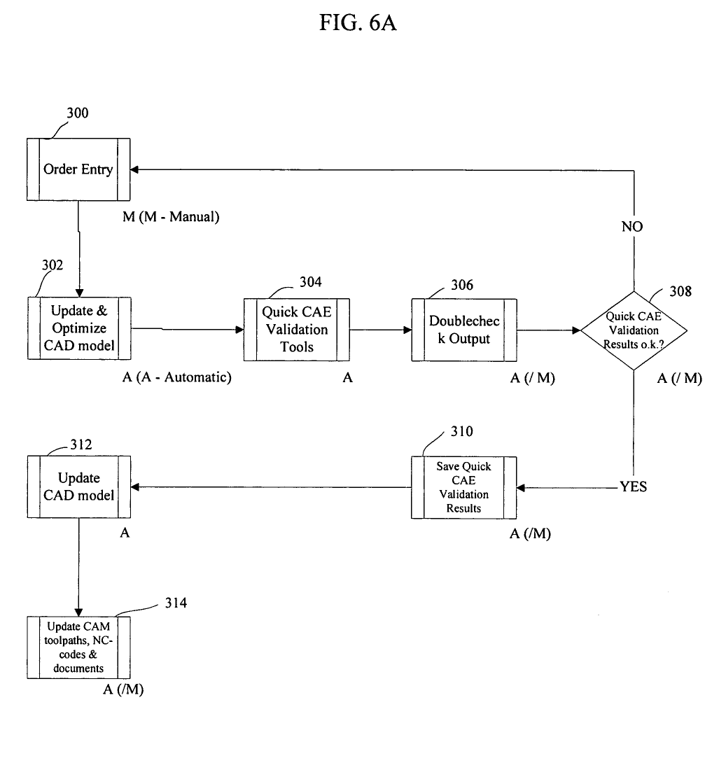

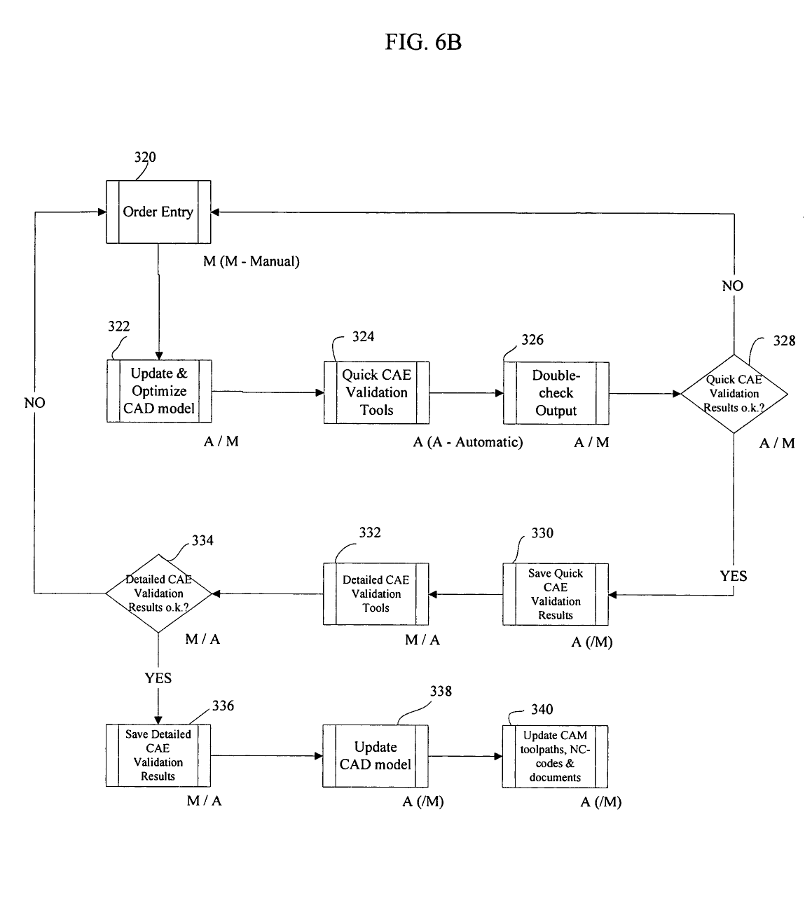

FIG. 6 is a block diagram of an example configuration of a network system to implement the system shown in FIG. 1. The illustrated network system 250 comprises an order entry mechanism 249, a CA computer system 252, an ERP or PLM computer system 254, machinists and/or machines 264, and a reporting module 268. An order entry—CA link 258 is provided to connect the order entry mechanism 249 with the CA computer system 252. An order entry—ERP and PLM link 260 is provided to link the order entry mechanism 249 with the ERP and PLM computer system 254. An inter-system link 256 is provided to link the CA computer system 252 with the ERP and PLM computer system 254. A machine interface or link 262 is provided to link the CA computer system 252 with the machinists or machines 264. A machine-ERP and PLM link 266 is provided to transfer data (e.g., setup times and run times) between machinist(s)/machine(s) 262 and the ERP and PLM system 254. A reporting—ERP and PLM link 269 is provided to link the ERP and PLM system 254 with the reporting module 268.

The illustrated links may each comprise an API or a data transfer protocol.

The modules and elements shown in FIG. 6 may each be manually controlled, partially automated, or fully automated.

Link 256 may comprise one or more databases for holding data that is common for use by both CA computer system 252 and ERP and PLM computer system 254. Alternatively, link 256 may comprise a standardized communication link using, for example, XML or some other type of command/response language or data transfer protocol. Machining interface or link 262 may comprise a document generation, program generation, or some other type of information display or link to facilitate the transport of programs or documents or other information generated by the CA computer system 252 for use by a machinist or a given machine 264. Each of links 266 and 269 may comprise standard data transfer or command and response languages for communication between the respective modules 264 and 268 and ERP and PLM computer system 254. Each of those modules may be implemented on computer platforms that are different from the ERP and PLM computer system 254, or they may be implemented within the same platform. Specifically, reporting module 268 may be a module that is part of the same ERP and PLM computer system 254.

CA computer system 252 comprises a parametric 3D model module 270, one or more analysis modules 272, and one or more simulation modules 274. Parametric 3D model module 270 may comprise a parametric design mechanism (not shown) to specify geometries of a part with parameters and a parametric link (not shown) to other parts of CA system 252. Such a link may employ, for example, for a given solid model, bidirectional associativity, so that elements of the model are associated in both directions between model module 270 and other system elements. An intelligent geometry portion 277 may be provided to determine machining cycles to manufacture the part, based on the information provided by the parametric 3D model 270. Parametric 3D model 270 further may have a 3D solid modeling function. A computer aided quality module 279 may also be provided, which may generate inspection sheets for use by the shop floor.

CA computer system 252 may further comprise an NC generator 275 to generate a standard machine—readable NC program from machining cycles that are determined from intelligent geometry portion 277.

ERP and PLM computer system 254 comprises part-related databases 280, which may comprise machine data reporting, inspection, and inventory status databases. ERP computer system 254 further comprises, in the illustrated embodiment, an RFQ/automated quote module 276, and a reporting database 278. ERP and PLM computer system 254 may further comprise a scheduling module 267, a bill of material (BOM) module 290, a production and vendor control module 292 (which may perform, among other functions, tool ordering tasks), and a module 294 to streamline and define work flow for the manufacturer.

In one embodiment, the NC generator 275 of CA computer system 252 may comprise a human-readable control program generator 285 to generate, from machining cycles produced by intelligent geometry portion 277, a human-readable program including instructions for a human to carry out. Those instructions may comprise a computer screen display of instructions regarding operating of a specialty machine. Those instructions may be further embodied in one or more documents and/or a computer screen display with instructions instructing manual input into a machine control portion of a specialty machine. The machine control portion generates from the manual input a proprietary control program.

A machinist/machine block 262 is provided, which indicates a machine system and the shop floor. As shown in FIG. 6, that system comprises a cell plan 287, a machine control portion 286 of a given specialty machine 288, and specialty machine 288.

Automation relieves employees from a routine job, so that the job can be done in a faster less expensive manner. Order processing can be automated by utilizing software, for example, software that is available on the market, which can eliminate the need for interfaces between departments within a given manufacturer organization. Such computer systems may further include built-in automation capabilities, such as bi-directional associativity, programming languages, feature recognition, and so on.

The various embodiments disclosed herein can be used to order, design, and manufacture different types of products. Products (custom parts) within the same part family may be ordered and manufactured, where such custom parts involve slight differences in dimension, shape, or contour. Products may be defined in different categories including standard and custom. A standard product may be a shelf-stock or catalogue item. Standard products may be run through a pre-defined (i.e., standardized) manufacturing process. Order processing of a standard product may involve pulling from a pre-defined file cabinet copies of a hardcopy template, and pulling CNC-programs and releasing the same to the shop. Manufactured products are stored on shelves in a warehouse.

A custom product may be a product for which a design of a product is triggered by the customer. A custom product may be engineered by the personnel of the manufacturer but fit into various features of a standardized system. A custom product is associated with an already existing product family. Custom products may or may not require minor or major adjustments in design, planning, and programming.

Custom products are run through a predefined manufacturing process. The custom products may be run through a parametric system, and the order process may be fully or partially automated. For example, the custom product may be produced from data entry to the automatic generation of a parametric model of a given custom part, to the automated operation of the CA system to produce NC code. NC code may be newly generated by the automated system.

An individual product may be a product for which the design comes from the customer. For example, a given customer may provide the manufacturer with a blueprint. A portion or all of the features of the individual product are called out by the customer, and may not fit into a standardized system of the manufacturer. An individual product may or may not be associated with an existing product family of the manufacturer. Usually, an individual product is a new product family. Individual products require partial or complete new engineering, planning, and programming. A portion of an individual product may be run through a pre-defined (standardized) manufacturing process. Other portions of the product may not be run through the parametric system, and depending upon design or necessity, order processing may or may not be automated. Once an individual product has been manufactured once, it evolves to a custom product for this specific customer.

Repeat orders are orders in which a part is produced in exactly the same manner as it was produced previously. Repeat orders include internally triggered repeat orders, for example, shelf-stock refills. In this case order processing is as described for a standard product. A repeat order may also be an externally triggered order. For example, a customer may contact the manufacturer and request the same exact part. Order processing may occur in this instance as a custom product.

An order may arrive in several different ways. An order may arrive from a customer as data values that can be applied to an existing CAD model. The model may be changed resulting in a new part. The order may be received by the manufacturer systems as data values from the customer that make it necessary to recreate a new CAD model or to amend an existing one. In this case new features are being added to an existing model. An order may arrive as an entire CAD model in three dimensions or a two-dimensional drawing from the customer.

FIGS. 6A and 6B show respective processes for the order processing of two different types of products. In FIG. 6A, standard, custom products are processed (level 1 processing). In FIG. 6B, high-end, individual products are processed (level 2 processing). In the process of FIG. 6A, the systems are set up so that the design value judgments and CAM NC-code generation are automated to a greater extent. This involves quick CAE validation tool/-s. In FIG. 6B, the process allows for manual value judgments, particularly on the design engineering side. The overall process is semi-automated,. While the process involves iterations, it is designed so that the iterations required are reduced.

Referring to FIG. 6A, at an initial act 300, data is input into the front-end mask. Specifically, data may be input into the entry interfaces illustrated in FIG. 3. In next act 302, the CAD model for the custom part is updated or optimized. In next act 304, quick CAE validation tools are employed. For example, the analysis module and automated simulation modules may be utilized to validate the model in act 304. In act 306 the output is double-checked. This may be done in an automated or manual fashion. If it is done in an automated fashion, automated simulation processes may be employed utilizing an automated simulation module within the CA computer system.

In act 308 a determination is made as to whether the quick CAE validation results are acceptable. This determination may be made in an automated fashion in accordance with a set of rules for the model and its analysis. The quick CAE validation may occur with a manual process by which a design engineer views the results of the analysis and simulation. Alternatively, this quick CAE validation may occur in an automatic fashion with rules in the computer system. If the validation results are not acceptable, the process returns to act 300. If the validation results are acceptable, the process proceeds to act 310. The quick CAE validation results are saved at that point. This may be an automatic step. The process then proceeds to act 312 where the CAD model is updated. Thereafter, at act 314, the process updates the CAM tool paths, and generates NC code and documents.

In FIG. 6B, in a first act 320, data is input into the front-end mask. Specifically, data may be input into the entry interfaces illustrated in FIG. 3. The process proceeds to act 322, where the CAD model is updated or optimized. This updating or optimization of the CAD model may be automatic or manual. The CAD model is then forwarded to act 324, where quick CAE validation tools are employed to validate whether the CAD model is of the appropriate design. Examples of quick CAE validation tools include a p-V-diagram and a calculation of bearing pressure. This act may be manual or automated. The process proceeds to act 326, where the output of the validation checking in act 324 is checked. This double-checking may be automatic or manual. If it is automatic, for example, an automated simulation process is performed by one or more automated simulation modules. The process proceeds to act 328, where a determination is made as to whether the validation results are acceptable. This can be an automated determination or a manual determination. The results of the simulation are viewed, and if they meet certain criteria set forth by certain rules originally set forth for the type of part being manufactured, a determination is made that the results are acceptable. If they are not acceptable, the process returns to act 320. If the validation results are acceptable, the process proceeds to act 330 where the quick CAE validation results are saved. The process then proceeds to act 332 where a detailed CAE validation occurs. The saving of the validation results in act 330 may be automated. Now, the detailed CAE validation may be done with a combination of both automated and manual processes. Automated simulation may occur, and a manual review of the simulation data may then be performed at this portion of the process.

The process proceeds from act 332 to act 334 where a determination is made as to whether the detailed CAE validation results are acceptable. The detailed CAE validation is done with one or both of a manual and an automated process. For example, an automated process may be employed by which a computer program determines if the simulation output results meet certain criteria. If they do, then the detailed CAE validation results are deemed to be acceptable. Alternatively, a design engineer may view the simulation results and make a determination that the detailed CAE validation results are acceptable. If the detailed CAE validation results are acceptable, the process proceeds to act 336, where the detailed CAE validation results are saved. The process then proceeds to act 338. When the detailed CAE validation results are not acceptable as determined at act 334, the process flows from act 334 to act 320. At act 338, the CAD model is updated. In a next act 340, CAM tool paths are updated, and NC code, and documents are generated.

Parametric CAD models and/or a parametric system will need to be set up in order to facilitate either of the processes shown in FIGS. 6A and 6B. A CAD model may be set for each such process in a flexible way so that it is possible for as many respective orders as possible to be followed. The initial setting of parametric models will save time downstream in the manufacturing process. A CA computer system is employed to facilitate the automation of certain design steps, for example, portions of the processes shown in FIGS. 6A and 6B. By way of example, the CAD system may produce an STL file which is a neutral file format that facilitates a rapid prototyping process. The STL file is an approximation of the geometry in the CAD file. Software is then employed to resolve corruptions in both the CAD model and the STL file. Such preparations are important so that defects do not corrupt an automated or semi-automated order process. Subsequently, other file processing is performed, for example, part orientation, support structures, and part placement.

This process may be called virtual prototyping. This involves a solid model visualization, design evaluation, and animation capabilities. This minimizes physical prototyping, by using 3D visualization and animation capabilities in the design cycle including the portions of the design cycle involving sales, marketing, and customer service.

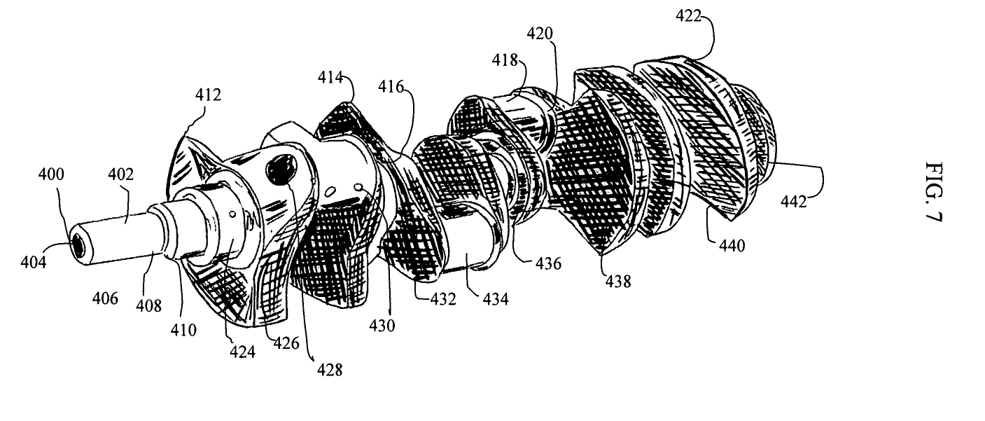

FIG. 7 is a perspective drawing of a shaft for an engine provided to facilitate visualization of a part that may be requested by a customer for custom manufacturing. The illustrated shaft is a shaft of a given automobile manufacturer. The illustrated shaft comprises a front bolt 400, a front hole 404, and a front retainer diameter 402. Other features of the illustrated shaft include front part 406, front retainer 408, front champfer 410, a front side of equipoise #1 412, a #2 center pin pad 416, a #3 off-center pin 418, off-center pin pad 420, and a #8 equipoise radius 422. The shaft further comprises a front center pin 424, a back side 426, a weight reduction hole 428, flow enhancement hole off-center pin #1 430, a equipoise cheek 432, a #2 off-center pin 434, a back end center pin face 436, a #6 equipoise 438, a mallory for weight equilibrium 440, and a back part 442.

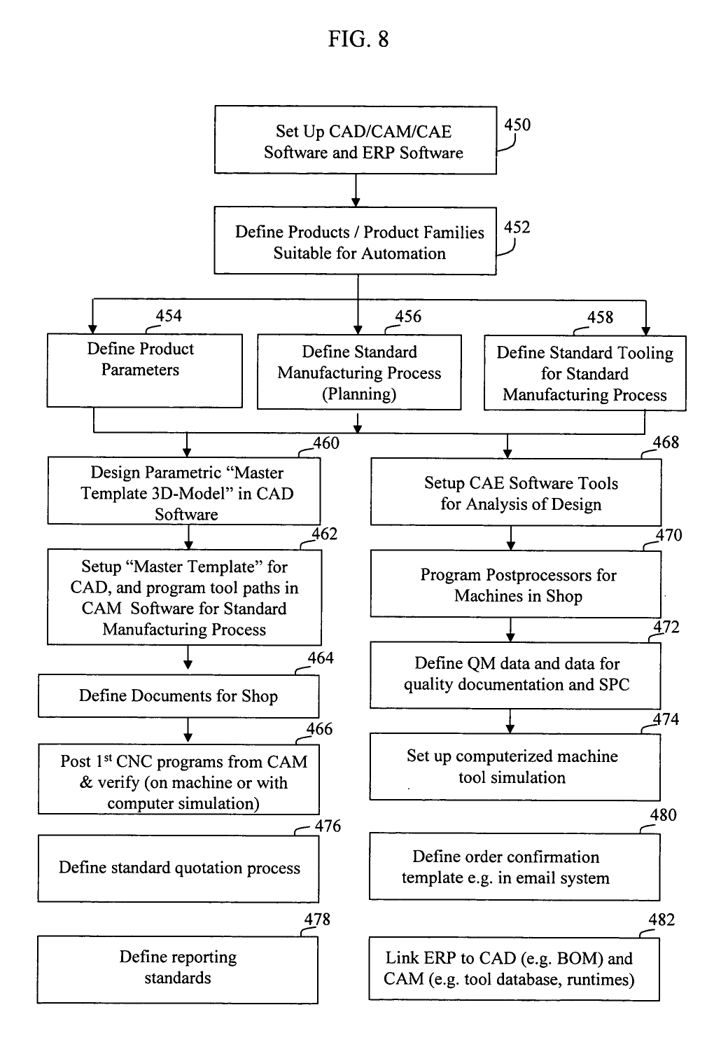

FIG. 8 is a flow diagram of a setup process, for example, for setting a manufacturer system for the automated order processing, design, and/or manufacture of a product family suitable for automation. Shafts are such a product family. During an initial act 450, the CA software and the ERP software are setup. In act 452, the products and product families are defined, which are suitable for automation. In act 454, the product parameters are defined. In act 456, the standard manufacturing process (planning) is defined. In act 458, the standard tooling is defined for the standard manufacturing process. As depicted in FIG. 8, each of acts 454, 456, and 458 may generally directly follow act 452. After acts 454, 456, and 458, a set of additional acts are performed. Act 460 is performed, which involves the design of the parametric master template 3D model in the CAD software. Then in act 462, the CAD master template is setup, and the tools paths are programmed with the computer aided manufacturing (CAM) software for the standard manufacturing process. In act 464, which follows act 462, documents are defined for the shop. In a next act 466, the first CNC programs are posted that are from CAM software, and they are verified on the machine.

In act 468, which follows acts 454, 456, and 458, the CAE software tools are set up to be able to analyze the design. In a next act 470, postprocessors for the machines in the shop are programmed to be able to generate NC-code from the CAM toolpaths. In a next act 472, the QM (quality management) data is defined for SPC (statistical process control) and quality documentation.

In a next act 474, the computerized machine tool simulation is setup. A number of other acts are performed, which may or may not be in any particular order with respect to the acts that are described above. These include the definition of a standard quotation process at act 476, the definition of reporting standards at 478, the definition of an order confirmation template, for example in an email system at act 480, and the linking of the ERP and PLM system to the CAD (e.g., BOM-bill of materials) and CAM systems. For example, such linking could involve linking of the tools database and the runtimes. These actions are act 482.

FIGS. 9A-9E collectively are a schematic diagram of an order entry interface, in five different parts. FIG. 9A starts with part one of the interface. A computer screen representation of the order entry interface may include any one or more different portions of this entire interface as shown in FIGS. 9A-9E. For example, a given screen shot may include a portion of the fields illustrated in FIG. 9A and other portions for example of FIG. 9B and FIG. 9D. Accordingly, the fields are presented without limiting the way they may be presented in an actual implementation of an order entry interface.

In part one shown in FIG. 9A, the order entry interface includes a number of fields for order entry. Each of the illustrated fields may comprise a field to allow direct alphanumeric text entry into that field by a computer user. The user may be the customer or a sales representative working for the manufacturer, for example, a sales engineer. An auto sales order identification field 500 is provided. Other fields include a date field 502 for the entry of date data, a set of customer information fields 504, which might include the name of the customer, the address of the customer, and other contact information. Customer information fields 504 may also include a customer number field. Invoice information may be captured in an invoice to field 506. Delivery information may be captured in a deliver to field 508. A manufacturer reference field 510 is provided. Other fields include a blanket order field 512, delivery terms 514, warranty information 516, payment terms 518, currency in which the customer will pay for the part 520, and a credit limit field 522. Other fields include balance 524, price group 526, commission group 528, delivery expected (which is a date by which the delivery of the product is expected by the customer) 530, packing costs 532, search key words 534, and extra text 536. The search key words field may simply comprise key words that can be used by the user to locate a particular order.

FIG. 9B illustrates part 2 of the order entry interface. FIG. 9B illustrates a set of data fields 566, 568, etc., for each part specified in a given order. The illustrated set of fields includes the item being ordered 538, the date of the order 540, a product identification alphanumeric code 542, the product description 544, the part number 546 (e.g. drawing no.), and the quantity ordered for that given part 548. Other fields include the price 550, the currency 552, the due date 554, the customer account 556, and the cost center 558. The cost center is a cost center of the manufacturer. A unit of measure field 560 is provided for specifying the quantity of the ordered product. A location field is provided for indicating the location at which the part is to be stored after manufactured.

FIG. 9C shows part 3 of the order entry interface. This includes part 1 of a custom order form; FIGS. 9D and 9E show parts 2 and 3 of the custom order. In FIG. 9C, the illustrated fields of the custom part order form include the serial number 580, the order date 582, the ship date 584, and the quantity 586. Other fields include the manufacturer reference number 588, the promise date 590, and customer information 592. Various financial information fields may be provided, including the base price 594, and a set of fields representing the cost of respective options of a shaft, including centrifugal force compensation 596, additional heavy metal 598, a premium upgrade 600, a type 1 cut shaft 602, and special drilling center pins 604. Additional option cost fields include an arch edge 606, a special hardening 608, a stroke variance 610, and type 2 flow enhancement holes 612. A total price field 614 is also provided. Additional financial fields include a credit card number field 616, and a set of fields 618 for other information related to the credit card.

Other fields include a remarks field 620, a material field 622, a heat/lot field 624, and a salesperson field 626. Sets of fields may be provided respectively for indicating shipping information, at 628, and drawing information, at 630. The drawing information can indicate the types of drawings provided by the customer. The information may include information identifying those drawings, and other information concerning the drawings such as the drawing files and the format of those files.

FIG. 9D shows part 4 of the illustrated order entry interface, and part 2 of the custom part order form. This part of the order entry interface generally comprises information concerning the design and technical parameters of a given shaft being ordered by the customer. Those fields shown in FIG. 9D include the part number 650, the connection length 652, and a set of information relating to each equipoise of the shaft, including a set fields for equipoise #1, a set of fields for equipoise #2, and so on up to equipoise #N. Each such set of fields includes, in this embodiment, a front side 654, a back side 656, an equipoise radius 658, and chamfer information 660.

FIG. 9D also includes sets of fields corresponding to the respective weight reduction holes of the shaft, including a set of fields for weight reduction hole #1, and so on until the last weight reduction hole #M. Each such set of fields includes, in this embodiment, a straight angle field 662, a throughput field 664, and an angle Front/Back field 667. A weight equilibrium field 668 is also provided. In addition, a plurality of fields 670 are provided for specifying weight requirements for the requested shaft.

FIG. 9E shows part 5 of the order entry interface, and part 3 of the custom part order form. The illustrated fields include engine information fields 672, a front part configuration field 674, and a wedge groove configuration field 676. Other fields include an flow enhancement configuration field 678, a back part field 680, and a set of special drilling information fields 682.

Additional fields are provided to describe each groove cut, particularly a set of fields corresponding to groove cut #1, and each groove cut thereafter up to groove cut #P. In addition, a set of off-center pin information fields is provided for each off-center pin from the first off-center pin #1 up until the last off-center pin #Q. A set of fields is provided to allow the specification of information concerning each of the center pins from the first center pin #1 up until the last center pin #R.

Other fields shown in FIG. 9E include a center pin radius field 684, a back part diameter field 686, a slinger diameter 688, a heat treatment field 690, and a set of approval fields 692. The approval fields may facilitate the approval of the data corresponding to the ordered custom part. Thus, both the customer and the sales or manufacturing or design engineer can indicate in these fields their approval of the custom part order form data.

FIG. 10 is a schematic diagram of an exemplary needs entry interface 700. The illustrated needs entry interface 700 comprises a tools list portion 702 and a material list portion 704. This entry interface 700 is coupled to one or more available inventory databases 710, which are coupled to inventory tracking and ordering systems 712. Inventory tracking and ordering systems may comprise of one or more modules of an ERP or PLM computer system.

The tool list portion 702 of needs entry interface 700 may comprise a mechanism for inputting plural sets of tool information, corresponding to each different tool that is necessary for the manufacturer of a given custom part. As illustrated, a given tool field set 720 may comprise a set of manipulable computer screen mechanisms to allow the input of data for each field. In the illustrated embodiment of FIG. 10, those fields included a tool field 722, a description field 724, a location field 726, and fields for indicating whether the tool is reserved 728, released 730, and/or ordered 732. In addition, a set of cost information fields 734 is provided. Scheduling information fields 736 are provided. In addition, fields are provided to indicate the quantity of the tool 738, and the units used to define that quantity 740.

The material list has a set of fields for a given material component 760. Such fields for a given material component 760 may comprise a field to describe the material 762, a location field 764, and a description field 766. Other fields indicate that the material is reserved 768, released 770, and/or ordered 772. Cost information fields 774 are provided. Scheduling information fields 776 are provided. Fields for indicating the quantity 778, and the units for describing the quantity 780, are also provided.

FIG. 11 is a schematic diagram of a sequence of operations planning entry interface. The data for a sequence of operations may be obtained by browsing or importing the data through the use of a browse/import button 802, or a new sequence may be specified by clicking on button 804. A set of data entry fields corresponding to each particular operation will be provided to allow the user to specify each field within that set. Each such operation set 810 may comprise a field such as an operation identification field 812. The operation identification field 812 may simply hold a number indicating the position of the operation within the sequence. An optional field 814 may be provided to indicate that the operation is optional for a given type of part or order. A description field 816 is provided to describe the operation. A setup time field 818 is provided to indicate the amount of time that is required to setup the machine for that operation. In addition, a run time field 820 is provided to indicate the amount of time expected to be required to run that operation. A quantity field 822 is provided to indicate the number of parts in a lot.

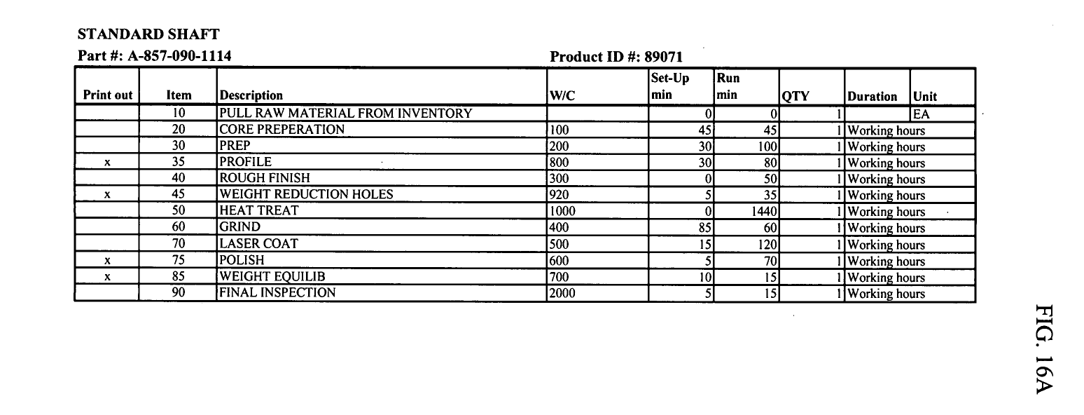

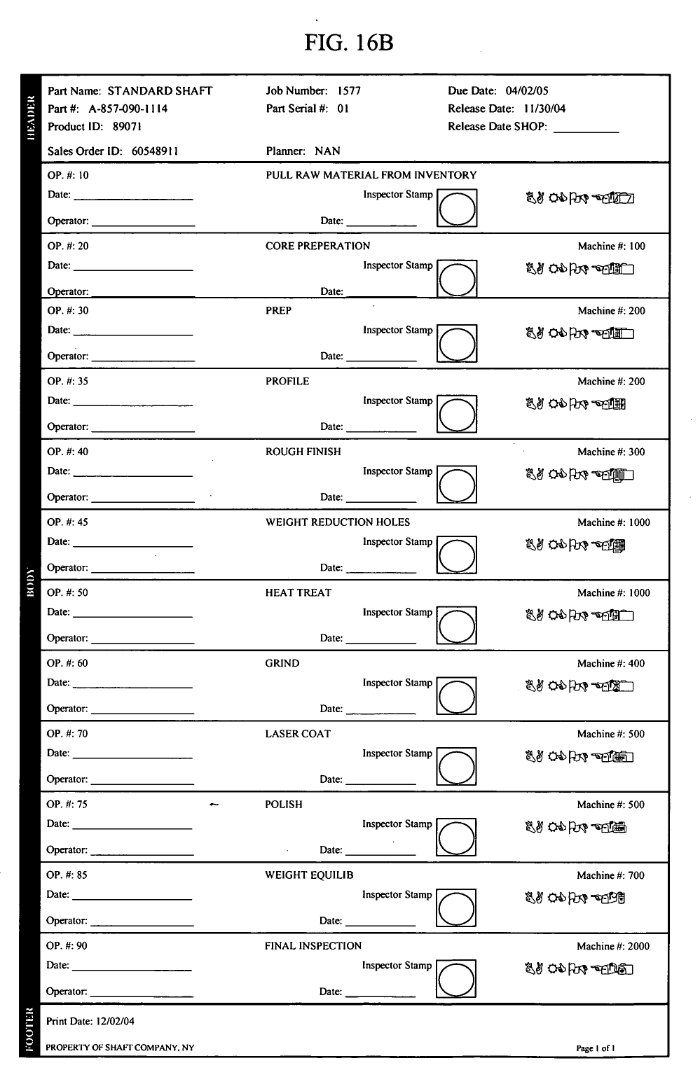

An example of the data produced for a complete sequence of operations for a given type of part is schematically illustrated at 830. FIG. 16A illustrates example planning information for a new order processing and execution for a given sequence of operations plan (a standard manufacturing process).

FIG. 12 is a schematic diagram of a machine loading and scheduling data entry interface 850 coupled to a machine loading and scheduling database 852. A machine loading and scheduling database 850 comprises portions for specifying information corresponding to each machine identification. Accordingly, a set of fields is provided for a given machine 860, including a machine identification field 862, a machine description field 864, and search terms corresponding to that machine 866. Other fields may include a work group field 868, a department field 870, and a cost center field to specify the cost center associated with that machine 872.

A set of shift parameters 874 may be provided, which can include fields for indicating the number of shifts per day, and the working hours per shift. A set of capacity fields 876 may be provided for indicating such information such as the utilization rate, the single capacity, the total capacity, the performance rate (in percentage), and a number of machines per employee. In addition, a set of overhead fields 878 may be provided. The overhead fields may indicate information such as the hourly rate information, and information as to whether the hourly rate is fixed, variable, actual, or planned. A set of display/visual aid options 880 may be chosen by the user to control the display of the populated data back to the user to facilitate review and revision of the data. Those display/visual aid options may allow the user to display certain information in bar code format, in waveform format, or in other graphical aid formats as appropriate.

FIG. 13 is an example of a populated portion of a technical mask for a given custom part, i.e., a given shaft.

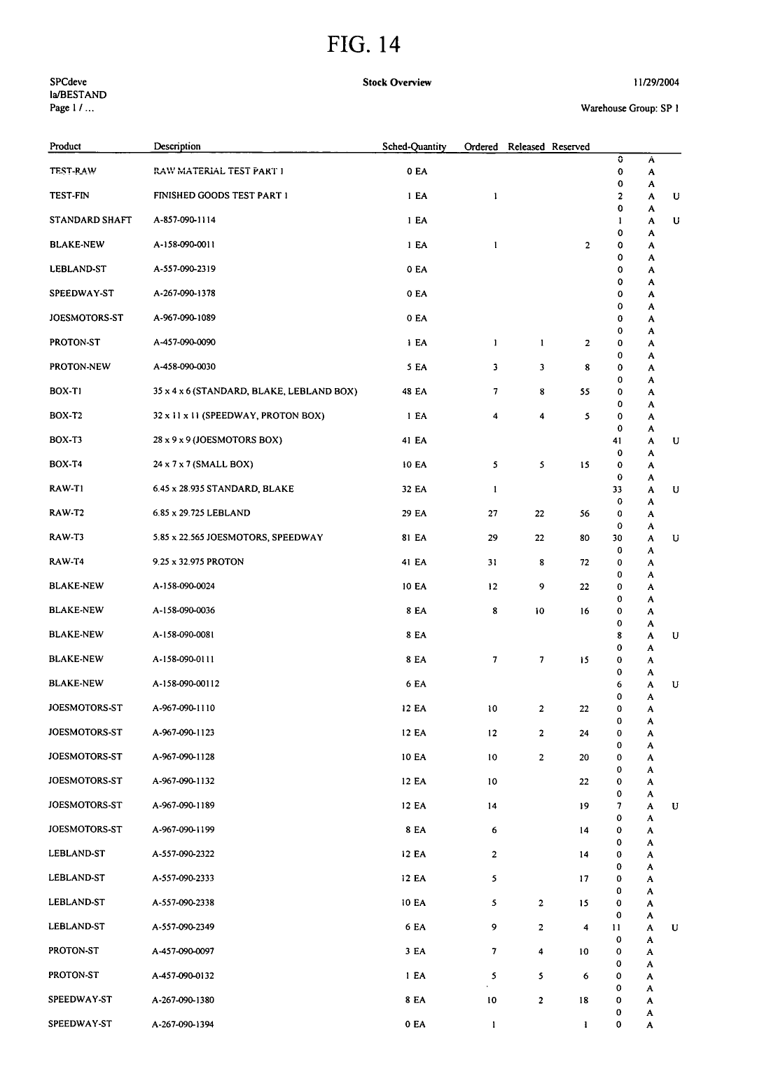

FIG. 14 illustrates a subset of stock overview data corresponding to a particular warehouse that can comprise part of the populated information for needs information that may be entered through needs entry interface 700 shown in FIG. 10.

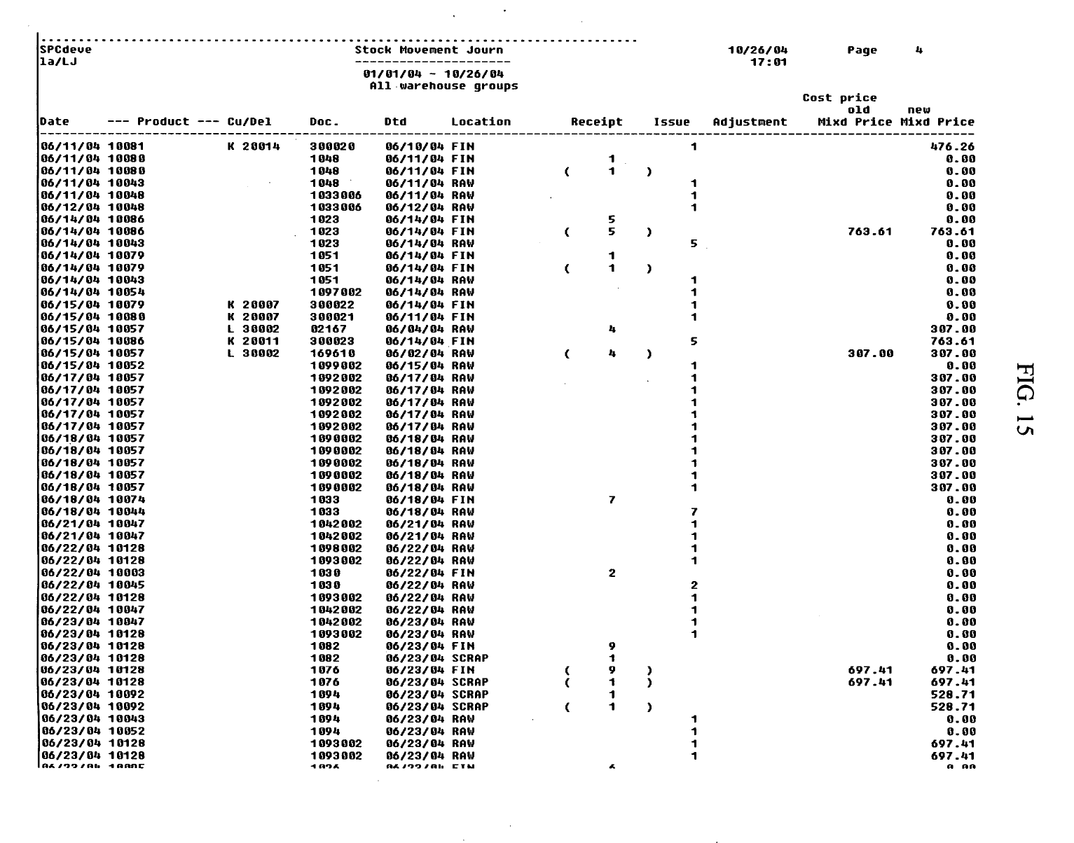

FIG. 15 illustrates populated data corresponding to a stock movement journal which also may be a portion of information that may be specified through needs entry interface 700 shown in FIG. 10.

FIG. 16A shows information for planning for a sequence of operations, including planning information for a new order processing for a given sequence of operations.

FIG. 16B is an example of a production plan, with a sequence of operations and bar codes for actual setup and runtimes to be input by a machine operator, e.g., manually or via a barcode scanner.

FIG. 17 illustrates an example RFQ. In a first step (1), a sales person may choose a new quotation tab. Then, in a second step (2), a quotation/blanket order template is displayed. The template has three parts in the embodiment shown in FIG. 17, i.e., address information (2), texts and conditions (3), and items (4).

FIG. 18 is an example of an automated quote. This quote is converted from the RFQ produced from inputting the necessary data in the templates shown in FIG. 17. The salesperson chooses the quote/blanket order at (1). Then, a list is displayed (2). By double clicking on a given quote at (2), a sales order (3) is generated.

FIG. 19 is an example of standard costing information. A quote can be built from this information.

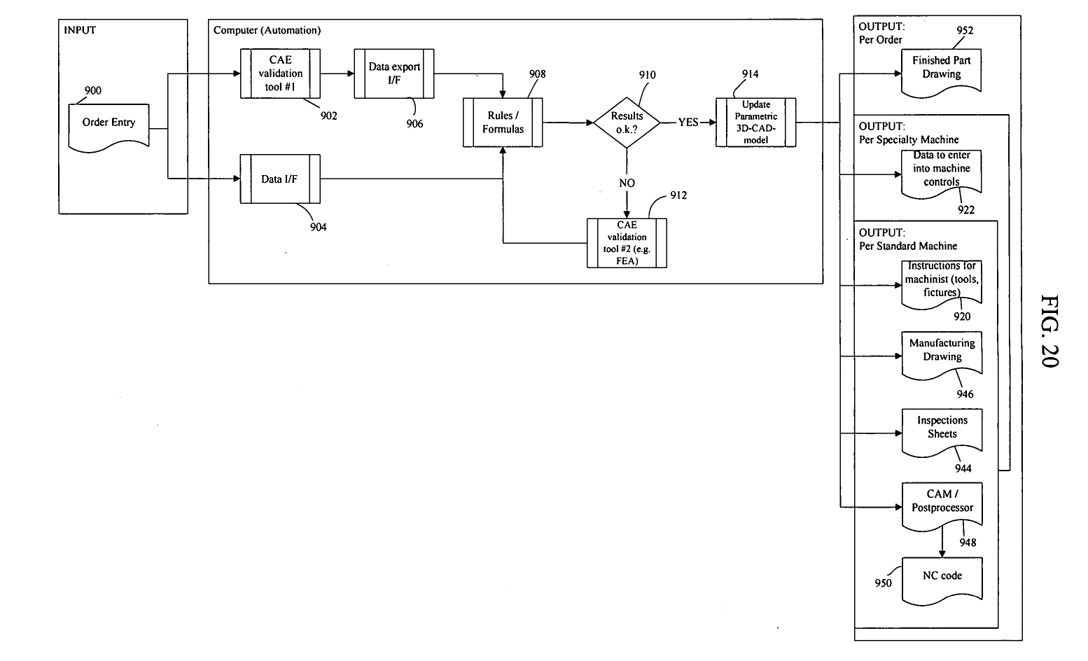

FIG. 20 is a flow chart for automated order processing and execution, and for programming of specialty machines and standard machines. In an input part of the process, customer data is input into an order entry front end at 900. Specifically, data may be input into the entry interfaces illustrated in FIG. 3. The process proceeds to acts 902 and 904. At act 902, a CAE validation tool is executed. Then, in act 906, data is exported with a data export interface 906. At act 904, a data interface, the data is converted to match the format of following step 908 (compatibility), e.g. via XML.

The process proceeds from acts 904 and 906 to 908, where certain rules and formulas are applied to determine if the data comports with certain requirements. A determination is made at act 910 as to whether a maximum has been exceeded. If the maximum has been exceeded, the process proceeds back to the CAE tool at act 912, and then returns to the rule/formula act 908 for additional testing. The CAE tool at 912 may be a Finite Element Analysis (FEA) tool for checking tensions or simulating bending, twisting and loading. The process proceeds from act 910 to 914, if the maximum was not exceeded. At act 914, parametric 3D CAD modeling is performed on the part. Various outputs are then produced. These outputs include, for specialty machines, instructions for a machinist 920 (including tools and fixtures), data 922 to enter into proprietary controls, and inspection sheets 944. In addition, for specialty machines, one or more manufacturing drawings 946 may be output. For a standard machine, the parametric 3D CAD model act then results in the output of a CAM/post processor data set 948, from which NC code 950 may be generated via a post processor. In addition, for standard machines, instructions for a machinist 920 (including tools and fixtures), inspection sheets 944, and one or more manufacturing drawings 946 may be output. For each order, an output is provided which includes a finished part drawing 952.

Referring to FIG. 6, a CA computer system may be provided which comprises a parametric design mechanism to carry out act 914, and to specify geometries of the part with parameters. An intelligent geometry mechanism may be provided to determine machining cycles to manufacture the part. A 3D solid modeling function is utilized in connection with rules and formulas at act 908, and one or more simulation components may be utilized as well at act 908 or 912. An NC (numerical code) generator may be provided to generate a standard machine-readable NC program from the CAM machining cycles for the generation of NC code, which occurs at act 948 and 950.

In the case of a specialty machine, a human-readable control program generator generates, from the CA computer system (e.g. the machining cycle and/or the parametric data set), a human-readable control program, which is in the form of instructions for the machinist and/or data to enter into a proprietary machine control, i.e., at acts 920 and 922. These instructions are carried out by a human. In alternate embodiments, the output proprietary control instructions may be in the form of a computer screen display of instructions regarding operation of a specialty machine. In addition, or in the alternative, documents and/or a computer screen display may be provided with instructions instructing manual input into a machine control portion of a specialty machine. The machine control portion generates from the manual input a proprietary machine control program.

In each of the above embodiments, if fields of one interface or populated data structure have (or are supposed to have) the same information as another (e.g. currency in FIG. 9A and 9B), then the data may be only entered once in one of those plural different locations. For example, a given value may be in a given field, e.g., because the given value was input into the field using a given interface. Meanwhile that same field in another interface may be populated so that the same given value is presented to the user as an option for input to the field in the other interface.

Each element described hereinabove may be implemented with a hardware processor together with computer memory executing software, or with specialized hardware for carrying out the same functionality. Any data handled in such processing or created as a result of such processing can be stored in any type of memory available to the artisan. By way of example, such data may be stored in a temporary memory, such as in a random access memory (RAM). In addition, or in the alternative, such data may be stored in longer-term storage devices, for example, magnetic disks, rewritable optical disks, and so on. For purposes of the disclosure herein, a computer-readable media may comprise any form of data storage mechanism, including such different memory technologies as well as hardware or circuit representations of such structures and of such data.

While the invention has been described with reference to certain embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials (e.g. custom and/or commercial software), the invention is not to be limited to the particulars disclosed, but rather extends to all equivalent structures, acts, and materials, such as are within the scope of the appended claims.

What is claimed is:

1. A part data entry system, comprising;
a part information receiving interface to receive part information;
an order processing template to facilitate sales and order processing, tool planning, computer aided (CA) parametric modeling, computer simulation, and the generation of a factory machine program, the order processing template comprising financial and manufacturing engineering planning fields and technical fields;
a part information population mechanism to populate the order processing template with the part information;
an order template population mechanism to populate other ones of the financial and manufacturing engineering planning fields and the technical fields that are not populated by the part information population mechanism;
an order processing template interface (i) to provide, for a given ordered part, from the order processing template, CA-specific information to a CA computer system before the CA computer system performs CA parametric modeling on the part, and (ii) to provide, for the given ordered part, from the order template, ERP-specific information to an ERP system before the ERP system performs scheduling of machines and resources, material reservation, or RFQ calculations.

2. The system according to claim 1, wherein the part information receiving interface comprises a computer screen input and receives the part information via the computer screen input.

3. The system according to claim 1, wherein the part information receiving interface comprises a web browser and receives the part information via the web browser.

4. The system according to claim 1, wherein the part information is provided by a customer.

5. The system according to claim 1, wherein the part information is provided by a sales engineering staff of a manufacturer.

6. The system according to claim 1, wherein the part information is provided directly from an online customer order.

7. The system according to claim 1, wherein the part information is provided to the part information receiving interface by phone.

8. The system according to claim 1, wherein the part information is received by the part information receiving interface by paper.

9. The system according to claim 1, wherein the order processing template comprises a set of preparation masks.

10. The system according to claim 9, wherein the set of preparation masks comprises a set of order execution preparation masks.

11. The system according to claim 1, wherein the CA parametric modeling comprises CAD/CAM parametric modeling.

12. The system according to claim 1, further comprising another information receiving interface to receive information for population of the other ones of the financial and manufacturing engineering planning fields and the technical fields.

13. The system according to claim 1, wherein the order template population mechanism comprises a mechanism to perform a data formula calculation to convert data from one form into another form for population of a given field of the order processing template.

14. The system according to claim 1, wherein the order processing template interface comprises a plurality of interfaces.

15. The system according to claim 1, wherein the CA-specific information comprises CAD/CAM/CAE—specific information to be provided to a CAD/CAM/CAE computer system.

16. The system according to claim 1, wherein the part information population mechanism comprises an application programming interface (API).

17. The system according to claim 1, wherein the order template population mechanism comprises an application programming interface (API).

18. A part data entry method, comprising;
receiving part information;
populating an order processing template with the part information, the order processing template comprising financial and manufacturing engineering planning fields and technical fields;
populating other ones of the financial and manufacturing engineering planning fields and the technical fields that are not populated by the part information population mechanism;
(i) providing, for a given ordered part, from the order processing template, CA-specific information to a computer aided (CA computer) system before the CA system performs CA parametric modeling on the part, and (ii) providing, for the given ordered part, from the order template, ERP-specific information to an ERP system before the ERP system performs scheduling of machines and resources, material reservation, or RFQ calculations.

19. The method according to claim 18, wherein the part information receiving interface receives the part information via a computer screen input.

20. The method according to claim 18, wherein the part information receiving interface receives the part information via a web browser.

21. The method according to claim 18, wherein the part information is provided by a customer.

22. The method according to claim 18, wherein the part information is provided by a sales engineering staff member of a manufacturer.

23. The method according to claim 18, wherein the part information is provided directly from an online customer order.

24. The method according to claim 18, wherein the part information is provided to the part information receiving interface by phone.

25. The method according to claim 1, wherein the part information is received by the part information receiving interface by paper.

26. The method according to claim 18, wherein the order processing template comprises a set of preparation masks.

27. The method according to claim 26, wherein the set of preparation masks comprises a set of order execution preparation masks.

28. The method according to claim 18, wherein the CA parametric modeling comprises CAD/CAM parametric modeling.

29. The method according to claim 18, further comprising another information receiving interface receiving information for population of the other ones of the financial and manufacturing engineering planning fields and the technical fields.

30. The method according to claim 18, wherein the order template population mechanism comprises a mechanism to perform a data calculation to convert data from one form into another form for population of a given field of the order processing template.

31. The method according to claim 18, wherein the order processing template interface comprises a plurality of interfaces.

32. The method according to claim 18, wherein the CA-specific information comprises CAD/CAM/CAE-specific information, and wherein the method comprises providing the CAD/CAM/CAE-specific information to a CAD/CAM/CAE computer system.

33. The method according to claim 18, wherein the part information population mechanism comprises an application programming interface (API).

34. The method according to claim 18, wherein the order template population mechanism comprises an application programming interface (API).
